(19) United States
(12) Patent Application Publication
(10) Pub. No.: US 2016/0025615 A1
(43) Pub. Date: Jan. 28, 2016

(54) METHOD AND APPLICATIONS FOR MEASUREMENT OF OBJECT TACTILE PROPERTIES BASED ON HOW THEY LIKELY FEEL TO HUMANS

(71) Applicant: SynTouch, LLC, Los Angeles, CA (US)

(72) Inventors: Jeremy A. Fishel, Fullerton, CA (US); Gerald E. Loeb, South Pasadena, CA (US); Blaine Matulevich, Pasadena, CA (US); Rahman Davoodi, Glendale, CA (US)

(73) Assignee: SynTouch, LLC, Los Angeles, CA (US)

(21) Appl. No.: 14/796,647

(22) Filed: Jul. 10, 2015

Related U.S. Application Data
(60) Provisional application No. 62/027,498, filed on Jul. 22, 2014.
(60) Provisional application No. 62/060,577, filed on Oct. 7, 2014.

(51) Int. Cl. G01N 19/00

(52) U.S. Cl. CPC G01N 19/00

(57) ABSTRACT

A system may measure, store, and recall at least one tactile property of multiple objects. The system may include one or more biomimetic tactile sensors that have mechanical properties and sensor modalities that are similar to those of human fingertips. The system may perform at least one exploratory movement on one of the objects by moving the biomimetic tactile sensors over a surface of the object. The at least one exploratory movement may be of a type that a human would normally perform on the object to discern the at least one tactile property and may have one or more movement parameters. Each of the movement parameters may fall within a range of movement parameters that would normally be exhibited if a human performed the exploratory movement for the at least one tactile property. The system may determine and store a value of the at least one tactile property based on information provided by the biomimetic tactile sensors in response to the exploratory movement. The determining may use an analytical function that specifies a mathematical relationship between the value and the information provided by the biomimetic tactile sensors that is based on physical phenomena, rather than extracted from data sets by an adaptive algorithm. The system may repeat the same exploratory movement performance, the same determining the value using the same analytical function, and the same storing the determined value for each of the other objects.

### CROSS-REFERENCE TO RELATED APPLICATION

This application is based upon and claims priority to U.S. provisional patent application 62/027,498, entitled “Method to Identify Materials Based on How They Are Likely To Feel To Humans,” filed Jul. 22, 2014, attorney docket number 085936-0028. This application is also based upon claims priority to U.S. provisional patent application 62/060,577, entitled “Apparatus and Method for the Characterization of Tactile Percepts of Pushing a Mechanical Button,” filed Oct. 7, 2014. This application is also related to U.S. PG Pub 2014/0195195, entitled “Object Investigation and Classification,” published Jul. 10, 2014. The entire content of each of these applications is incorporated herein by reference.

### STATEMENT REGARDING FEDERALLY SPONSORED RESEARCH

This invention was made with government support under Grant No. 1345335 awarded by National Science Foundation. The government has certain rights in the invention.

### BACKGROUND

1. Technical Field

This disclosure relates to determining tactile properties of objects.

2. Description of Related Art

### General Background on Need, Challenges, and Limitations of Non-Biomimetic Approaches

The feel of a consumer product when touched or otherwise handled by a customer or user is an important attribute that may affect its desirability and value. The designer of a consumer product may need to find candidate materials that have a suitable feel and to find sources of supply and/or identify manufacturing processes that result in a desired specification of product feel. The purchasers of a product may desire some assurance that a candidate product will have the desired feel. While standards such as the Pantone® Matching System (Pantone Inc., Carlstadt, N.J.) exist for quantifying color as it relates to human vision, no suitable standard may exist for quantifying how surfaces feel.

Tribology is the science and engineering of interacting surfaces in relative motion. If one or both of those surfaces are biological tissues, such studies belong to the subfield of biotribology. One such interaction is that of a human hand exploring a material. Current state-of-the-art methods to provide descriptions of how surfaces feel include using expert sensory panels consisting of individuals who have been trained to perform exploratory movements and describe what they feel (Meilgaard, M C, Civille, G V, and Carr, B T. 2007. “Sensory Evaluation Techniques” (pp. 202-223). Boca Raton, Fla.: Taylor & Francis Group.). While such an approach can provide highly relevant information to product developers, these descriptions can be highly subjective and qualitative by their very nature, are highly influenced by fatigue, and can vary between evaluators or even day-to-day for any given evaluator. To standardize human judgment it has been proposed to provide reference surfaces as evaluators make measurements of various tactile properties. Products such as the Sensotact developed by Renault and the Touch Feel reference system by Ziegler Instruments are available, but ultimately may be limited by the skill and ability of the human judge providing these ratings, so they may suffer from the same problems of subjectivity and lack of repeatability as expert sensor panels.

In contrast with expert sensory panels, which can provide highly relevant information that may not be repeatable or precise, conventional tribological instruments may be capable of providing measurements of bulk materials and surfaces that are very precise and repeatable, but may not be relevant to human perception. Examples of these include standardized test equipment to measure engineering properties such as hardness, coefficient of friction, surface finish, etc. These machines generally use probes that may not have either the mechanical properties or the sensory capabilities of human fingertips. Therefore, these interactions may be mechanically very different from the interactions between such materials and a human fingertip and their measurements may not correlate with human perception.

Some objects may have complex, dynamic behaviors that depend on how they are handled, such as the pushbutton switches that are used in keyboards, control panels and other human control interfaces. A typical approach that has been used in the characterization of pushbuttons is to measure the force-travel characteristic as a pushbutton is depressed and released (Enigk, H, Foehl, U, and Wagner, V. 2008. “Haptics research at Daimler AG”. In Human Haptic Perception: Basics and Applications (pp. 453-458). Birkhauser Basel.). In this research, measurements may include actuation force (the force required to actuate the pushbutton), lead travel (the distance traveled before the actuation point), snap jump (the distance between the actuation point and the next point with equivalent force), total travel (the distance moved to exert maximum force), and differential force (difference between compression and releasing force at actuation point). While these approaches may appear to be comprehensive to an engineer familiar with stress-strain curves, problems may exist in relating these measurements to human perception. For example, the human fingertip has its own compliance that represents a significant portion of the distance moved. Furthermore, the tendons driving the human fingertip are elastic structures in series with muscles that generate forces that depend nonlinearly on instantaneous length and velocity, as opposed to position-controlled machines. The exploratory movements made by pushbutton testing machines may result in mechanical interactions that bear little resemblance to the dynamics that would occur between a pushbutton and a human fingertip, which a human perceives through tactile sensation.

The ability to provide repeatable and precise measurements of properties that are directly relevant to human touch perception appears to have remained elusive, despite being of high interest to many industries that would benefit from such a technology. The ability to quantifiably measure such properties may provide many benefits: improving quality control of finished products to verify that there are no observable differences to a human observer, streamlining product development by eliminating costs of expert sensory panels to verify that a certain product feel has been achieved, and improvements to the sourcing of similar feeling materials by eliminating costly sample books that need to be manually explored sample by sample.

Human touch typically requires movements to be made with fingertips in order to sense information about what the fingers are touching. The nature of these movements may be optimized to extract the tactile properties of an object that may be useful for identifying or characterizing the object. Experimental psychologists have observed a number of useful types of exploratory movements that humans make when identifying objects by touch, such as hefting, enclosing, applying pressure, and sliding. (Lederman, S J, and R L Klatzky. 1987. “Hand Movements: a Window Into Haptic Object Recognition.” Cognitive Psychology 19: 342-368.). However, even within these discrete sets of movements, there may be many ways in which these movements can be executed to collect information. For instance, different combinations of forces and sliding trajectories could be made when performing a sliding movement. Despite the large number of possible movements and variations in parameters, humans achieve effective and efficient tactile characterization of objects by selecting a well-practiced, standardized exploratory movements.

Human skin contains a variety of neural transducers that sense mechanical strain, vibrations, and thermal information (Jones, L A, and S J Lederman. 2006. Human Hand Function. New York, N.Y.: Oxford University Press, USA.; Vallbo, A B, and R S Johansson. 1984. “Properties of Cutaneous Mechanoreceptors in the Human Hand Related to Touch Sensation.” Human Neurobiology 3 (1): 3-14.). The skin and its sensory transducers are highly evolved and specialized in structure, and the glabrous skin found on the palmar surface of the human hand, and in particular the fingertip, may possess a higher density of cutaneous receptors than the hairy skin on the rest of the body (Vallbo, A B, and R S Johansson. 1978. “The Tactile Sensory Innervation of the Glabrous Skin of the Human Hand.” In Active Touch, the Mechanism of Recognition of Objects by Manipulation, edited by G Gordon, 29-54. Oxford: Pergamon Press Ltd.; Johansson, R S, and A B Vallbo. 1979. “Tactile Sensibility in the Human Hand: Relative and Absolute Densities of Four Types of Mechanoreceptive Units in Glabrous Skin.” Journal of Physiology 286 (1): 283.). A device known as the BioTac® that mimics these sensory capabilities has been described in a form factor that has similar size, shape and mechanical properties of the human fingertip (U.S. Pat. No. 7,658,110, No. 7,878,075, No. 8,181,540 and No. 8,272,278, SynTouch LLC, Los Angeles, Calif.). Other tactile sensors designed to replicate human touch have been described in a number of literature reviews covering several decades of research (Nicholls, H R, and M H Lee. 1989. “A Survey of Robot Tactile Sensing Technology.” International Journal of Robotics Research 8 (3): 3-30.; Howe, R D. 1994. “Tactile Sensing and Control of Robotic Manipulation.” Advanced Robotics 8 (3): 245-261.; Lee, M H, and H R Nicholls. 1999. “Tactile Sensing for Mechatronics—a State of the Art Survey.” Mechatronics 9: 1-31.; Dahiya, R S, G Metta, M Valle, and G Sandini. 2010. “Tactile Sensing—From Humans to Humanoids.” IEEE Transactions on Robotics 26 (1): 1-20.).

Another approach is artificial texture recognition with tactile sensors (Tada, Y, K Hosoda, and M Asada. 2004. “Sensing Ability of Anthropomorphic Fingertip with Multi-Modal Sensors.” In Proc. IEEE International Conference on Intelligent Robots and Systems, 1005-1012.; Mukaibo, Y, H Shirado, M Konyo, and T Maeno. 2005. “Development of a Texture Sensor Emulating the Tissue Structure and Perceptual Mechanism of Human Fingers.” In Proc. IEEE International Conference on Robotics and Automation, 2565-2570. IEEE.; Hosoda, K, Y Tada, and M Asada. 2006. “Anthropomorphic Robotic Soft Fingertip with Randomly Distributed Receptors.” Robotics and Autonomous Systems 54 (2): 104-109.; de Boissieu, F, C Godin, B Guilhamat, D David, C Serviere, and D Baudois. 2009. “Tactile Texture Recognition with a 3-Axial Force MEMS Integrated Artificial Finger.” In Proc. Robotics: Science and Systems, 49-56.; Sinapov, J, and A Stoytchev. 2010. “The Boosting Effect of Exploratory Behaviors.” In Proc. Association for the Advancement of Artificial Intelligence, 1613-1618.; Giguere, P, and G Dudek. 2011. “A Simple Tactile Probe for Surface Identification by Mobile Robots.” IEEE Transactions on Robotics 27 (3): 534-544.; Oddo, C M, M Controzzi, L Beccai, C Cipriani, and M C Carrozza. 2011. “Roughness Encoding for Discrimination of Surfaces in Artificial Active-Touch.” IEEE Transactions on Robotics 27 (3): 522-533.; Jamali, N, and C Sammut. 2011. “Majority Voting: Material Classification by Tactile Sensing Using Surface Texture.” IEEE Transactions on Robotics 27 (3): 508-521.; Sinapov, J, V Sukhoy, R Sahai, and A Stoytchev. 2011. “Vibrotactile Recognition and Categorization of Surfaces by a Humanoid Robot.” IEEE Transactions on Robotics 27 (3): 488-497.; Chu, V, I McMahon, L Riano, C G McDonald, Q He, J M Perez-Tejada, M Arrigo, et al. 2013. “Using Robotic Exploratory Procedures to Learn the Meaning of Haptic Adjectives.” In Proc. IEEE International Conference on Robotics and Automation.). The sliding movements humans make when identifying surface texture (Lederman, S J, and R L Klatzky. 1987. “Hand Movements: a Window Into Haptic Object Recognition.” Cognitive Psychology 19: 342-368.) may be executed with these sensors over a number of textures to identify which characteristics make them unique. Various approaches to producing these movements have been explored, including using anthropomorphic hands (Tada, Y, K Hosoda, and M Asada. 2004. “Sensing Ability of Anthropomorphic Fingertip with Multi-Modal Sensors.” In Proc. IEEE International Conference on Intelligent Robots and Systems, 1005-1012.; Hosoda, K, Y Tada, and M Asada. 2006. “Anthropomorphic Robotic Soft Fingertip with Randomly Distributed Receptors.” Robotics and Autonomous Systems 54 (2): 104-109.; Oddo, C M, M Controzzi, L Beccai, C Cipriani, and M C Carrozza. 2011. “Roughness Encoding for Discrimination of Surfaces in Artificial Active-Touch.” IEEE Transactions on Robotics 27 (3): 522-533.; Jamali, N, and C Sammut. 2011. “Majority Voting: Material Classification by Tactile Sensing Using Surface Texture.” IEEE Transactions on Robotics 27 (3): 508-521.; Chu, V, I McMahon, L Riano, C G McDonald, Q He, J M Perez-Tejada, M Arrigo, et al. 2013. “Using Robotic Exploratory Procedures to Learn the Meaning of Haptic Adjectives.” In Proc. IEEE International Conference on Robotics and Automation.), 2-axis plotting machines (de Boissieu, F, C Godin, B Guilhamat, D David, C Serviere, and D Baudois. 2009. “Tactile Texture Recognition with a 3-Axial Force MEMS Integrated Artificial Finger.” In Proc. Robotics: Science and Systems, 49-56.), robotic arms (Sinapov, J, V Sukhoy, R Sahai, and A Stoytchev. 2011. “Vibrotactile Recognition and Categorization of Surfaces by a Humanoid Robot.” IEEE Transactions on Robotics 27 (3): 488-497.), or manual sliding (Giguere, P, and G Dudek. 2011. “A Simple Tactile Probe for Surface Identification by Mobile Robots.” IEEE Transactions on Robotics 27 (3): 534-544.). Previous studies employed a fixed exploration sequence for collecting data, which, after processing, was fed into a machine learning classifier that sought to identify the texture. One exception was (Jamali, N, and C Sammut. 2011. “Majority Voting: Material Classification by Tactile Sensing Using Surface Texture.” IEEE Transactions on Robotics 27 (3): 508-521.), who repeated the same sliding movement until the classification reached a desired confidence. In all of the above cases, machine learning classifiers were used to extract patterns in collected data for classification purposes, rather than using direct analytical calculations to compute material properties. Limitations of such an approach may require first developing a rich set of testing data to train the classifier, and generally more advanced performance may require exponentially more training data, a phenomenon well known in machine learning as the “curse of dimensionality” (Jain, A K, Duin, R P W, and Mao, J. 2000. “Statistical Pattern recognition: a review”. IEEE Trans. Pattern Anal. Mach. Intell. 22, 4-37.).

Using a variety of exploratory movements has been demonstrated to improve performance (Sinapov, J, V Sukhoy, R Sahai, and A Stoytchev. 2011. “Vibrotactile Recognition and Categorization of Surfaces by a Humanoid Robot.” IEEE Transactions on Robotics 27 (3): 488-497.). However, executing every possible movement to gain all information about an object may be impractical, so these systems were restricted to a small number of preprogrammed exploratory movements. This approach may only provide marginal performance accuracies when using a small number of highly distinctive surfaces that would be trivial for a human observer to discriminate. Examples of classification performance in previous literature include: 62% over 10 textures (de Boissieu, F, C Godin, B Guilhamat, D David, C Serviere, and D Baudois. 2009. “Tactile Texture Recognition with a 3-Axial Force MEMS Integrated Artificial Finger.” In Proc. Robotics: Science and Systems, 49-56.), 89.9-94.6% over 10 textures (Giguere, P, and G Dudek. 2011. “A Simple Tactile Probe for Surface Identification by Mobile Robots.” IEEE Transactions on Robotics 27 (3): 534-544.), 95% over 20 textures (Sinapov, J, V Sukhoy, R Sahai, and A Stoytchev. 2011. “Vibrotactile Recognition and Categorization of Surfaces by a Humanoid Robot.” IEEE Transactions on Robotics 27 (3): 488-497.), 97.6% over 3 textures (Oddo, C M, M Controzzi, L Beccai, C Cipriani, and M C Carrozza. 2011. “Roughness Encoding for Discrimination of Surfaces in Artificial Active-Touch.” IEEE Transactions on Robotics 27 (3): 522-533.), and 95% over 8 textures (Jamali, N, and C Sammut. 2011. “Majority Voting: Material Classification by Tactile Sensing Using Surface Texture.” IEEE Transactions on Robotics 27 (3): 508-521.).

Loeb et al., 2011, (Loeb, G E, G A Tsianos, J A Fishel, N Wettels, and S Schaal. 2011. “Understanding Haptics by Evolving Mechatronic Systems.” Progress in Brain Research 192: 129-144.), suggested the general desirability of selecting exploratory movements incrementally according to the most likely identity of the object being explored, but provided no examples or methods to do so. Fishel and Loeb, 2012, (Fishel, J A, and G E Loeb. 2012. “Bayesian Exploration for Intelligent Identification of Textures.” Frontiers in Neurorobotics 6(4): 1-20.) described a formal method for exploring objects called Bayesian exploration that was derived from classical Bayesian probability and decision-making methods. Fishel and Loeb, 2012, applied Bayesian exploration with considerable success to the identification of objects based upon their surface textures, which is included herein by reference (U.S. patent application Ser. No. 14/151,625).

### SUMMARY

A system may measure, store, and recall at least one tactile property of multiple objects. The system may include an object test system that includes one or more biomimetic tactile sensors that have mechanical properties and sensor modalities that are similar to those of human fingertips. The system may include one or more mechanical actuators that controllably move the one or more biomimetic tactile sensors, a data processing system, and a data storage system. The system may perform at least one exploratory movement on one of the objects by causing the mechanical actuators to move the biomimetic tactile sensors over a surface of the object. The at least one exploratory movement may be of a type that a human would normally perform on the object to discern the at least one tactile property and have one or more movement parameters. Each of the movement parameters may fall within a range of movement parameters that would normally be exhibited if a human performed the exploratory movement for the at least one tactile property. The system may also determine a value of the at least one tactile property based on information provided by the biomimetic tactile sensors in response to the exploratory movement. The determining may use an analytical function that specifies a mathematical relationship between the value and the information provided by the biomimetic tactile sensors that is based on physical phenomena, rather than extracted from data sets by an adaptive algorithm. The system may store the determined value in the data storage system along with information identifying the object. The system may repeat the same exploratory movement performance, the same determining the value using the same analytical function, and the same storing the determined value for each of the other objects. The system may read the determined value for each of one or more of the objects from the data storage system.

The object test system may include a temperature or humidity sensor.

The system may use data from the temperature or humidity sensor to adjust the analytical function.

The system may use data from the temperature or humidity sensor to regulate environmental conditions of the object test system.

The object test system may include a fingerprint scanner. The system may use data from the fingerprint scanner to determine a state of wear, inflation, or compliance of at least one of the biomimetic tactile sensors.

One of the multiple objects may have a non-linear contour. The at least one exploratory movement may include changes in elevation and/or orientation of at least one of the biomimetic tactile sensors that cause the at least one of the biomimetic tactile sensors to follow the contour of the object.

At least one of the biomimetic tactile sensors may be connected to at least one of the mechanical actuators by an elastic coupling.

The system may correlate the determined value of the tactile property for each of the objects to one or more linguistic tactile descriptors that a human uses to describe how an object feels.

The system may determine the value of each of multiple different properties of each of the multiple objects.

The system may scale the determined values of at least two of the different properties so that the ranges of the majority of the values for the at least two different properties are substantially the same.

The system may determine the similarity between at least one pair of objects by computing a Euclidean distance between the values of each of the different tactile properties of the pair of objects.

The system may scale the determined values of at least two of the different properties so that the same increment of value for each of the at least two different properties corresponds to the smallest difference that a human can discriminate for tthat property.

The system may cause the data storage system to store values of tactile properties of the objects that have been determined by more than one test systems.

The system may cause the data storage system to store data for each object that describes non-tactile properties of the object.

The system may compute a cost function for each object and identify one or more of the objects that satisfy one or more requirements based on the determined cost functions.

The tactile property may be macrotexture roughness; the biomimetic tactile sensors may include a vibration sensor that produces a time-varying signal indicative of vibration; the exploratory movement may include sliding the vibration sensor across a surface of the object with a normal force in the range of 0.2-2 N and a tangential velocity in the range of 0.5-10 cm/s; and the analytical function may determine a measure of vibration intensity in the time-varying signal in a frequency band that is within 5-100 Hz.

The tactile property may be microtexture roughness; the biomimetic tactile sensors may include a vibration sensor that produces a time-varying signal indicative of vibration; the exploratory movement may include sliding the vibration sensor across a surface of the object with a normal force in the range of 0.2-2 N and a tangential velocity in the range of 0.5-10 cm/s; the analytical function may determine a measure of vibration intensity in the time-varying signal in a frequency band that is within 20-800 Hz.

The tactile property may be macrotexture coarseness; the biomimetic tactile sensors may include a vibration sensor that produces a time-varying signal indicative of vibration; the exploratory movement may include sliding the vibration sensor across a surface of the object with a normal force in the range of 0.2-2 N and a tangential velocity in the range of 0.5-10 cm/s; and the analytical function may determine a measure of vibration frequency in the time-varying signal in a frequency band that is within 5-100 Hz.

The tactile property may be microtexture coarseness; the biomimetic tactile sensors may include a vibration sensor that produces a time-varying signal indicative of vibration; the exploratory movement may include sliding the vibration sensor across a surface of the object with a normal force in the range of 0.2-2 N and a tangential velocity in the range of 0.5-10 cm/s; and the analytical function may determine a measure of a vibration frequency in the time-varying signal in a frequency band that is within 20-800 Hz.

The tactile property may be macrotexture regularity; the biomimetic tactile sensors may include a vibration sensor that produces a time-varying signal indicative of vibration; the exploratory movement may include sliding the vibration sensor across a surface of the object with a normal force in the range of 0.2-2 N and a tangential velocity in the range of 0.5-10 cm/s; and the analytical function may determine a measure of a distribution of vibration frequency content in the time-varying signal in a frequency band that is within 5-100 Hz.

The tactile property may be tactile stiction; the system may computes a time-varying signal indicative of tangential force; the exploratory movement may include sliding a biomimetic tactile sensor across a surface of the object with a normal force in the range of 0.2-2 N and a tangential velocity in the range of 0.5-10 cm/s; and the analytical function may determine a measure of a peak tangential force in the time-varying signal as the biomimetic tactile sensor transitions from rest to sliding.

The tactile property may be tactile sliding resistance; the system may compute a time-varying signal indicative of tangential force; the exploratory movement may include sliding a biomimetic tactile sensor across a surface of the object with a normal force in the range of 0.2-2 N and a tangential velocity in the range of 0.5-10 cm/s; and the analytical function may determine a measure of average tangential force in the time-varying signal.

The tactile property may be tactile stick-slip chatter; the system may compute a time-varying signal indicative of tangential force; the exploratory movement includes sliding a biomimetic tactile sensor across a surface of the object with a normal force in the range of 0.2-2 N and a tangential velocity in the range of 0.5-10 cm/s; and the analytical function may determine a measure of variation in the tangential force in the time-varying signal.

The tactile property may be tactile compliance; the system may compute time-varying signals indicative of normal force and displacement; the exploratory movement may include pushing a biomimetic tactile sensor into a surface of the object with a normal force in the range of 0.2-15 N; and the analytical function may determine a measure of a ratio of displacement to normal force in the time-varying signals.

The tactile property may be tactile deformability; the biomimetic tactile sensors may use a sensor that measures pressure or a distributed array of force and that produce a time-varying signal indicative of local deformation; the exploratory movement may include pushing a biomimetic tactile sensor into a surface of the object with a normal force in the range of 0.2-15 N; and the analytical function may determine a measure of the local deformation from the time-varying signal.

The tactile property may be tactile damping; the system may compute time-varying signals indicative of normal force and displacement; the exploratory movement may include pushing a biomimetic tactile sensor into a surface of the object with a normal force in the range of 0.2-15 N and then reducing that force while maintaining contact with the object; and the analytical function may determine a measure of a ratio of energy recovered from the object during the lifting to energy required to compress the object in the time-varying signals.

The tactile property may be tactile relaxation; the system may compute time-varying signals indicative of normal force; the exploratory movement may include pushing a biomimetic tactile sensor into a surface of the object with a normal force in the range of 0.2-15 N and holding the biomimetic tactile sensor in place; and the analytical function may determine a measure of change in the normal force while the biomimetic tactile sensor is held in place from the time-varying signal.

The tactile property may be tactile yielding; the system may compute time-varying signals indicative of displacement; the exploratory movement may include pushing a biomimetic tactile sensor into a surface of the object with a normal force in the range of 0.2-15 N and then reducing that force while maintaining contact with the object; and the analytical function may determine a measure of a ratio of displacement recovered after reduction of force to displacement imposed during the pushing from the time-varying signals.

The tactile property may be thermal cooling; one of the biomimetic tactile sensors may include at least one temperature sensor within it that produces a time-varying signal indicative of heat transfer into or out of the at least one temperature sensor; the exploratory movement may include pushing the one of the biomimetic tactile sensors against a surface of the object with a normal force in the range of 0.2-15 N and holding the one of the biomimetic tactile sensors in place after the pushing; and the analytical function may determine a measure of a rate of heat transfer in the time-varying signal that takes place between 1-5 seconds after the one of the biomimetic tactile sensors contacts the object.

The tactile property may be thermal persistence; one of the biomimetic tactile sensors may include at least one temperature sensor within it that produces time-varying signals indicative of heat transfer into or out of the at least one temperature sensor; the exploratory movement may include pushing the one of the biomimetic tactile sensors at least one temperature sensor into a surface of the object with a normal force in the range of 0.2-15 N and thereafter holding the one of the biomimetic tactile sensors in place; and the analytical function may determine a measure of a rate of heat transfer in the time-varying signal that takes place between 5-15 seconds after the one of the biomimetic tactile sensors contacts the object.

The tactile property may be adhesion; the system may compute time-varying signals indicative of normal force; the exploratory movement may include pushing a biomimetic tactile sensor against a surface of the object with a normal force in the range of 0.2-15 N and then lifting the biomimetic tactile sensor off of the object; and the analytical function may determine a measure of change in the normal force while the biomimetic tactile sensor is lifted off of the object from the time-varying signal.

One of the test objects may be a pushbutton; the tactile property may be actuation force, click intensity, total travel, or deactivation click intensity; the biomimetic tactile sensors may include a vibration sensor; the system may compute time-varying signals indicative of normal force and displacement; the exploratory movement may include pushing the vibration sensor against a surface of the pushbutton with an increasing normal force until the pushbutton actuates and then releasing the force while allowing the pushbutton to push the biomimetic tactile sensor back up; and the analytical function may determine an amount of force required to actuate the pushbutton from the time-varying force signal, an intensity of vibrations during the actuation, total travel during the pushing, or intensity of vibrations during the release.

The system may generate and display or print an image that represents at least one tactile property of at least one object based on the determined value of the at least one tactile property of the object.

The system may include a tactor. The system may control the tactor based on the determined value of the at least one tactile property of one of the objects. The system may adjusts the determined value of the at least one tactile property of the object before the system controls the tactor.

A non-transitory, tangible, computer-readable storage medium containing a program of instructions may cause any of the foregoing systems to perform any of the foregoing functions or any combination thereof.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of an object investigation and classification system that may have the ability to capture tactile information from an object, store that information in a database, and recall and display that information to a human observer.

FIGS. 2A-2B illustrate an example of the object test system illustrated in FIG. 1 that can explore tactile properties of a flat surface. FIG. 2A illustrates a side view; FIG. 2B illustrates a front view.

FIG. 3 illustrates an example of the object test system illustrated in FIG. 1 that can explore tactile properties of a contoured surface.

FIG. 4 illustrates an example of the object test system illustrated in FIG. 1 that can explore tactile properties of a pushbutton.

FIG. 5 illustrates an example of the recall and display system illustrated in FIG. 1 that can generate reports about collected objects or simulate an object on a tactile display.

FIG. 6 illustrates an example of a data collection sequence that can be used for the object investigation and classification system illustrated in FIG. 1 to collect information about one or more objects.

FIG. 7 illustrates an example of objects with different tactile properties measured by the object investigation and classification system illustrated in FIG. 1

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

The BioTac® (SynTouch LLC, Los Angeles, Calif.) is a biomimetic tactile sensor that has physical form and mechanical properties similar to a human fingertip, including elastomeric skin with fingerprints, rigid bonelike core, and incompressible fluid between them, and that further incorporates transducers of skin deformation and vibration and thermal flux resulting from contact with materials and surfaces to be characterized (U.S. Pat. No. 7,658,110, No. 7,878,075, No. 8,181,540 and No. 8,272,278).

Conventional actuators and motion control hardware can be used to build specialized robots that perform controlled exploratory movements such as stroking and palpating materials in a manner similar to humans exploring such materials and surfaces (Fishel, J A, and G E Loeb. 2012. “Bayesian Exploration for Intelligent Identification of Textures.” Frontiers in Neurorobotics 6(4): 1-20.; Su, Z, J A Fishel, T Yamamoto, and G E Loeb. 2012. “Use of Tactile Feedback to Control Exploratory Movements to Characterize Object Compliance.” Frontiers in Neurorobotics 6(7): 1-12.; Xu, D., Loeb, G. E. and Fishel, J., “Tactile identification of objects using Bayesian exploration,” IEEE-ICRA, Karlsruhe, Germany, May 6-10, 2013.).

A system that associates actions and resulting sensory information for the computation of percepts has been described previously and is incorporated herein in its entirety by reference (U.S. patent application Ser. No. 14/151,625).

In order to measure tactile properties of objects in a manner similar to how they are perceived by humans, it may be useful to employ a biomimetic tactile sensor that has mechanical properties and sensory transducers that are similar to those in the human fingertip. It may also be useful to employ humanlike exploratory movements to create relative motion between the biomimetic tactile sensor and an object to be characterized, in which the movements have kinematic and kinetic properties that are similar to the exploratory movements that humans make. We have reported previously how this strategy may be used to develop a database that can be searched to identify one of a previously explored set of textures (Fishel, J A, and G E Loeb. 2012. “Bayesian Exploration for Intelligent Identification of Textures.” Frontiers in Neurorobotics 6(4): 1-20.; U.S. patent application Ser. No. 14/151,625.). The descriptive language that humans use to describe different attributes of a material (e.g. “soft”, “rough”, “warm”, etc.) may be used to design analytical functions that translate the raw data from the sensory transducers into sensory dimensions that correspond to those attributes.

Throughout the narrative, we refer to the “feel” of an object to reflect the sum total of tactile experiences that a human observer may have when touching, palpating, stroking, or similarly exploring said object. We include in “object” any singular or composite structure of one or more natural and/or synthetic substances that can be explored by human finger and hand movements.

The human fingertip has evolved and now has many mechanical properties and features that determine the manner in which it interacts with objects. The various sensory nerve receptors in the fingertip then transduce the mechanical events that occur during this interaction into electrical signals in the sensory nerve fibers that are transmitted to the central nervous system. These electrical signals are interpreted by the brain in the context of the exploratory movement that has been made and the subject's prior experience with this and all other materials. The personal and idiosyncratic nature of these exploratory movements and prior experiences results in verbal descriptions that are subjective, personal and inconsistent between subjects, although generalizations may be possible such as by statistical analysis of the descriptions from a set of subjects.

Definitions
An ACTOR is a component that can interact with the OBJECT so as to cause it to generate information.
An ACTUATOR is an ACTOR designed to mechanically interact with the OBJECT so as to cause it to generate information that is dependent on this mechanical interaction.
An ACTION is a particular interaction that the ACTOR can perform with the OBJECT.
A HUMANLIKE EXPLORATORY MOVEMENT is an ACTION performed by one or more ACTUATORS to cause a BIOMIMETIC TACTILE SENSOR to interact with an OBJECT in a similar fashion as humans would typically employ when exploring the OBJECT by touch.
A SENSOR is a component that can detect or receive information from the OBJECT.
A TACTILE SENSOR is a SENSOR that can detect or receive information from the OBJECT that is touch-based.
A BIOMIMETIC TACTILE SENSOR is a TACTILE SENSOR that has mechanical properties and sensory capabilities that are similar to the human fingertip.
An OBJECT is any physical thing that is capable of interacting with one or more ACTORS and producing information that can be detected or received by one or more SENSORS.
A PERCEPT is an abstraction of signals from the one or more SENSORS that reflects a characteristic of the OBJECT.
An ANALYTICAL FUNCTION is a mathematical function whose form and parameter values are based on universal physical principals, rather than statistical extractions from arbitrary data sets, such as performed by neural networks and similar adaptive algorithms.
An EXPERIENCE DATABASE contains a record or summary of previously executed ACTIONS and the associated PERCEPTS of one or more OBJECTS with one or more classifications.
A TACTILE PROPERTY is a scale whose values represent the PERCEPTS obtained from OBJECTS during HUMANLIKE EXPLORATORY MOVEMENTS.
A LINGUISTIC TACTILE DESCRIPTOR is a qualitative or quantitative description of one aspect of the feel of an object as perceived by a human observer.

### Measurement System

Various systems for measuring, storing and recalling standardized tactile properties that individually correspond to human perception are now described.

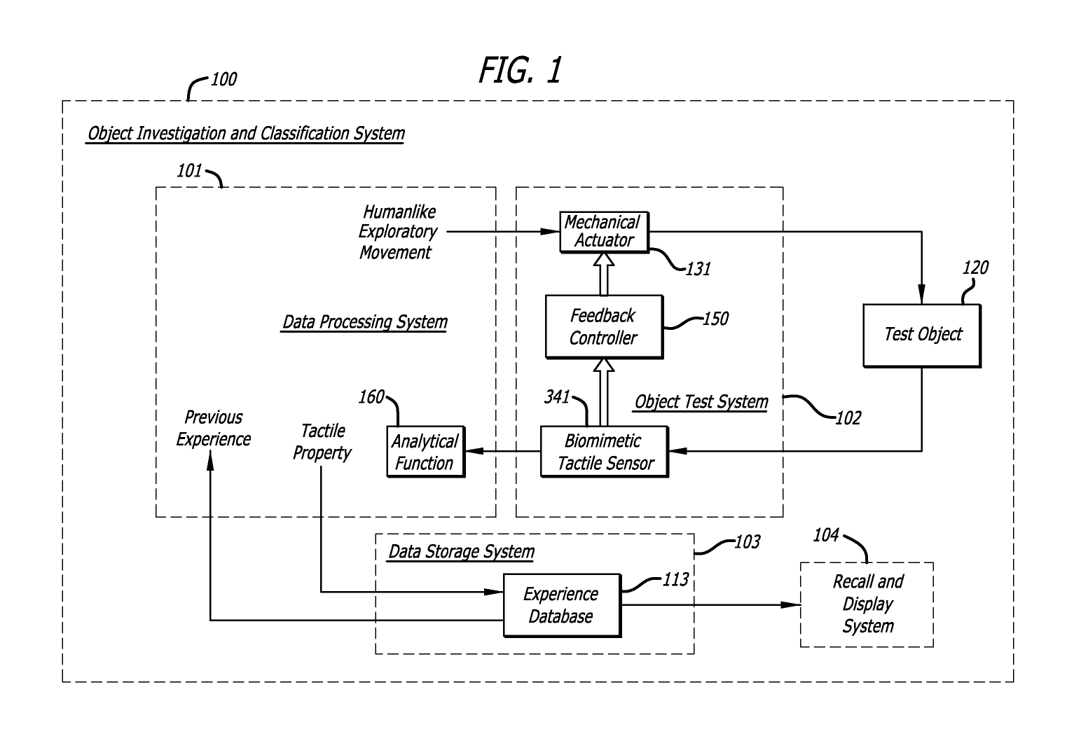

FIG. 1 illustrates an example of an object investigation and classification system 100 that may have the ability to capture tactile information from an object 120, store that information in a database, and recall and display that information to a human observer.

Referring to FIG. 1, the object investigation and classification system 100 may include a data processing system 101, object test system 102, data storage system 103, and recall and display system 104.

Still referring to FIG. 1, the object test system 102 may contain one or more mechanical actuators 131, one or more sensors, and one or more feedback controllers 150. One or more of the one or more sensors may be biomimetic tactile sensors 341 that have mechanical properties and sensory capabilities similar to the human fingertip, such as, but not limited to, the BioTac (SynTouch, LLC, Los Angeles, Calif.). Other sensors may also be used to detect mechanical responses such as, but not limited to, load cells, strain gauges, position encoders, Hall-effect sensors, and related devices familiar to those skilled in the art of sensory instrumentation of mechanical systems.

Still referring to FIG. 1, the one or more mechanical actuators 131 may move a biomimetic tactile sensor 341 over the object 120 to elicit mechanical interactions that can be sensed by the biomimetic tactile sensor 341 or other sensors. The movements performed by the mechanical actuators 131 may be humanlike exploratory movements that are sequenced with the ranges of forces and velocities that humans typically employ when exploring objects by touch. The mechanical actuators 131 may be any component designed to cause the biomimetic tactile sensor 341 to interact physically with the object 120 under test, such as, but not limited to, linear stages or rotary stages and related devices familiar to those skilled in the art of mechanical systems. The mechanical actuators 131 may possess or incorporate mechanical compliance to improve smoothness or humanlike verisimilitude of movement and control of mechanical forces, such as, but not limited to, mechanical actuators that use technology based on pneumatics, hydraulics, springs, or other passive or active compliance familiar to those skilled in the art of mechatronics.

Still referring to FIG. 1, object 120 under test may be a surface, material, or other object with tactile properties that can be sensed by the biomimetic tactile sensor 341 or other sensors described above that may otherwise be detectable by human touch.

Still referring to FIG. 1, the feedback controller 150 may be a proportional-integral-derivative controller that uses information detected by the one or more sensors or biomimetic tactile sensors 341 to control the one or more mechanical actuators 131 using linear or non-linear methods, as well as other feedback control techniques, as familiar to those skilled in the arts of feedback control of mechanical systems. For example, the signals generated by the interaction of the biomimetic tactile sensor 341 and the object 120 may depend on the amount of force with which the biomimetic tactile sensor 341 is applied to the object 120 via movements from the mechanical actuators 131. If the biomimetic tactile sensor 341 or other sensors provides information regarding that force, then that information can be provided to the feedback controller 150 to assure that the mechanical actuators 131 perform the desired humanlike exploratory movement with the desired force. If the mechanical actuators 131 possess compliance, then this control may be simplified as familiar to those skilled in the art of mechatronics.

Still referring to FIG. 1, the data processing system 101 may be programmed to control the one or more mechanical actuators 131 that may be capable of performing one or more humanlike exploratory movements to interact with an object 120 that is under test. The one or more biomimetic tactile sensors 341 or other sensors may be capable of detecting or receiving information that results from this interaction between the one or more biomimetic tactile sensors 341 and object 120 and deliver this information to the data processing system 101, which seeks to determine properties of object 120 from this sensory data using analytical functions 160. These humanlike exploratory movements may be a predefined sequence of force, velocity or position, or any combinations of these. The humanlike exploratory movements may be any particular humanlike exploratory movement that the one or more actuators can perform with object 120.

Still referring to FIG. 1, the sensory information received by the one or more biomimetic tactile sensors 341 or other sensors may be used by the data processing system 101 to compute one or more of tactile properties that result from interactions between the one or more biomimetic tactile sensors 341 and object 120 that is under test. If the biomimetic tactile sensor 341 is moved over the surface of object 120 by the mechanical actuators 131, the tactile properties may be computed from analytical functions 160 that process the sensory data, such as, but not limited to, the power of measured vibrations to compute the roughness of the surface or other methods, including, but not limited to, those listed below. The tactile properties may be any particular abstraction of signals from the one or more biomimetic tactile sensors 341.

The object investigation and classification system 100 may be able to perform a large number of humanlike exploratory movements with its one or more mechanical actuators 131 and to compute a large number of tactile properties derived from information detected or received by the one or more sensors or one or more biomimetic tactile sensors 341.

Still referring to FIG. 1, the data storage system 103 may contain an experience database 113 that contains records associating previously executed humanlike exploratory movements with previously computed tactile properties. The previously executed humanlike exploratory movements may be performed by one or more mechanical actuators 131 with previously-observed objects 120. The resulting one or more tactile properties may be abstracted from signals obtained from one or more sensors or one or more biomimetic tactile sensors 341 during this interaction. The records of the experience database 113 may be labeled with one or more classifications such as, but not limited to, object identification information. The records of the experience database 113 may also contain information about nontactile properties of the object, such as but not limited to mechanical strength, visual appearance, and financial cost. The records of the experience database 113 may also contain additional information about the operation of object test system 102 including, but not limited to, timestamps related to when the tactile property was computed and other relevant environmental data such as ambient temperature, humidity or the location of where the test was performed. The experience database 113 may also simplify these data into descriptive statistics that adequately describe the tactile properties of a given classification, a given previously-observed reference object, or a given encounter with a previously-observed reference object, including, but not limited to, mean, mode, standard deviation, variance, kurtosis, skewness, standard error of the mean, number of entities observed, probability density functions, cumulative distribution functions, probability mass functions, histograms and other descriptive statistics that are familiar to those skilled in the art of descriptive statistics.

Still referring to FIG. 1, information contained in the experience database 113 may be delivered to the data processing system 101. The data processing system 101 may utilize this information in the experience database 113 to determine if the object 120 currently being explored is similar to or different than previously explored objects. Information in the experience database 113 may also be used by the data processing system 101 to actively control the selection of humanlike exploratory movements to be performed by the mechanical actuators 131, as described in (Fishel & Loeb, “Object Investigation and Classification System”, US Patent Application 2014/0195195, 2014).

Still referring to FIG. 1, information contained in the experience database 113, may be used by the recall and display system 104 to present this information to a human observer in an interpretable format, such as reports, or by driving a tactor, which is a tactile display device that can controllably simulate the feel of different objects, as described in more detail below.

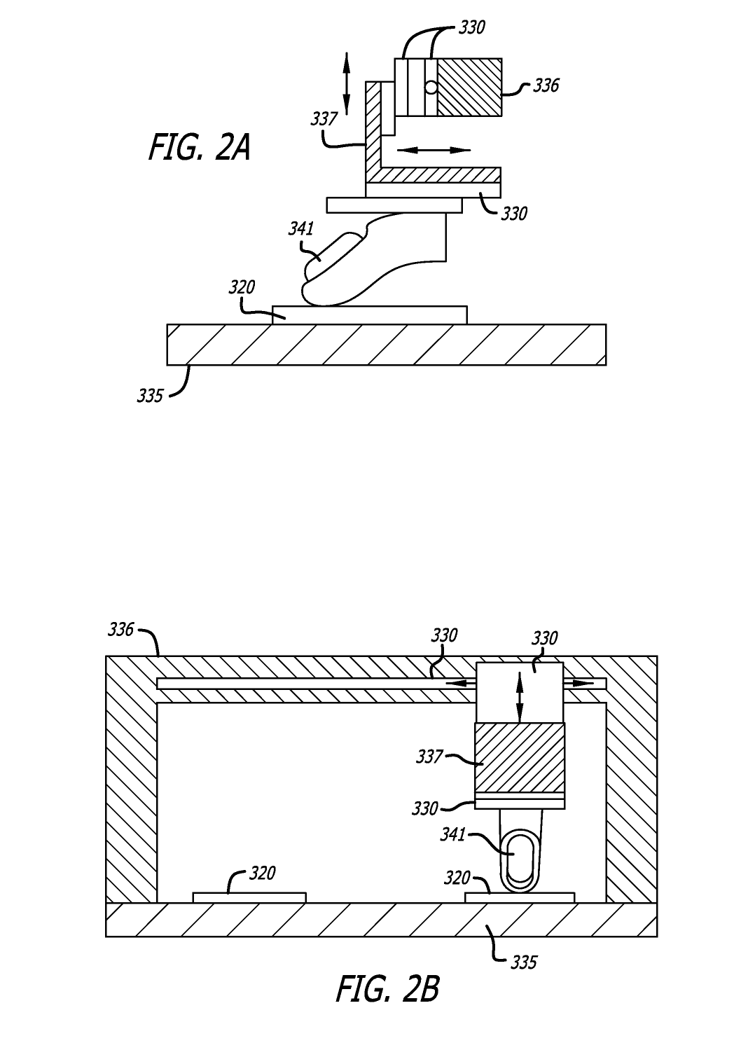

FIGS. 2A-2B illustrates an example of the object test system 102 illustrated in FIG. 1 that can explore tactile properties of a tactile surface 320. FIG. 2A illustrates a side view; FIG. 2B illustrates a front view.

Referring to FIG. 2A, an object test system 102 that can explore the tactile properties of an object 120 that is a tactile surface 320 may consist of a base 335, gantry 336, series of linear actuators 330, and a biomimetic tactile sensor 341.

Still referring to FIG. 2A, an object investigation and classification system 100 for determining the tactile properties of an object 120 may include: 1) an apparatus that includes one or more linear actuators 330 capable of moving a biomimetic tactile sensor 341 to perform humanlike exploratory movements that are similar to the ones humans make when exploring objects by touch, 2) a biomimetic tactile sensor 341 whose sensory capabilities, sensitivity, resolution, and mechanical properties and interactions with objects being explored are similar to those of human fingertips, 3) feedback controllers 150 that make use of information from the biomimetic tactile sensor 341 and other sensors instrumented on the linear actuators 330 to control exploratory movements, 4) signal processing strategies including analytical functions 160 for the measurement of tactile properties that correspond to the linguistic tactile descriptors observed by humans when identifying tactile properties of objects, 5) an experience database 113 containing information from previous experience exploring objects that includes and associates the descriptors of each humanlike exploratory movements with the linguistic tactile descriptors of objects, and 6) applications of these tactile exploration, measurement and perception technologies in quality control and product design.

Still referring to FIG. 2A, an apparatus including one or more linear actuators 330 capable of moving a biomimetic tactile sensor 341 to perform humanlike exploratory movements may include a base 335, gantry 336, linear actuators 330, mechanical adapter 337 and a biomimetic tactile sensor 341. The gantry 336 may be attached to the base 335 to hold a series of linear actuators 330 coupled together with mechanical adapters 337 that position the biomimetic tactile sensor 341 over a tactile surface 320. Other assembly arrangements including all or some of these components which permit for positioning and moving the biomimetic tactile sensor 341 over the tactile surface 320 may be possible as familiar to those skilled in the arts of mechanical system design. The gantry 336, base 335, and mechanical adapters 337 may be made of any family of engineering materials suitable as structural materials, including, but not limited to, metals, plastics, ceramics, or any other family of materials as familiar to those skilled in the art of engineering design. The base 335 may have a high mass to dampen vibrations from external sources. The linear actuators 330 may be any type of device capable of creating movement in a straight line such as hydraulic actuators, pneumatic actuators, piezoelectric actuators, electro-mechanical actuators, or any other type of actuator capable of creating motion in a straight line as familiar to those skilled in the art of actuation. Other actuators that do not necessarily produce motion in a straight line may be used, provided that the assembled system imitates humanlike exploratory movements, such as those that incorporate tendons or pulleys and other actuation technology familiar to those skilled in the art of mechatronic design. The linear actuators 330 may be programmed to move the biomimetic tactile sensor 341 over the tactile surface 320 with a movement profile that resembles a humanlike exploratory movement. These humanlike exploratory movements may be similar to the movements humans make when exploring objects by touch and may include, but are not limited to, pressing the biomimetic tactile sensor 341 into the tactile surface 320 with a predetermined profile of force, velocity, displacement, or combination of force, velocity, and displacement, sliding the biomimetic tactile sensor 341 over the tactile surface 320 with a predetermined trajectory of velocities in one or more directions, or any of the above movements using sensory data from the biomimetic tactile sensor 341 to control force, displacement or velocity as described below.

A biomimetic tactile sensor 341 whose sensory capabilities, sensitivity, resolution, and mechanical properties and interactions with objects being explored are similar to those of human fingertip may be a device such as the BioTac (SynTouch LLC, Los Angeles, Calif.). The ability of the biomimetic tactile sensor 341 to produce interactions between the tactile surface 320 that are similar to those that would be produced when interacting with a human fingertip may benefit from the biomimetic tactile sensor 341 having similar mechanical properties as the human fingertip such as similar compliance, shape, size and may also benefit from the biomimetic tactile sensor 341 having similar features as the human fingertip such as a fingernail that facilitates the transduction of tangential forces applied to the fingerpad, and fingerprints that enhance vibrations induced and sensed when sliding the biomimetic tactile sensor 341 over a textured surface.

The ability of the biomimetic tactile sensor 341 to perceive sensations similar to those a human may perceive when exploring the tactile surface 320 may benefit from the biomimetic tactile sensor 341 having sensory modalities similar to those found in human skin such as sensitivity to contact location, normal and tangential forces, vibrations, and temperature. In one embodiment, biomimetic tactile sensor 341 has a rigid core whose surface includes a multiplicity of electrodes that sense deformations of the overlying skin as changes in the electrical impedance of a conductive liquid that inflates the skin over the core. Biomimetic tactile sensor 341 may be equipped with a fluid pressure sensor that is connected to the liquid so as to detect pressure changes indicative of compressive forces applied to the overlying skin or vibrations induced by sliding motions between the overlying skin and an external object. Biomimetic tactile sensor 341 may be internally heated electrically and equipped with a temperature sensor such as a thermistor that can detect temperature changes that result from contact with objects at various temperatures. A biomimetic tactile sensor 341 that meets all of these capabilities may be the BioTac (SynTouch LLC, Los Angeles, Calif.).

The feedback controllers 150 that make use of information from the biomimetic tactile sensor 341 or sensors instrumented on the linear actuators 330 to control exploratory movements may include the ability to control the specified force of the linear actuator 330 in the normal axis. The specified force in the linear actuator 330 in the normal axis may be controlled using feedback controllers 150 that may make use of sensory information from the biomimetic tactile sensor 341 or other sensors instrumented on the linear actuator 330 in the normal axis, such as force plates, motor current sensors, strain gauges or other technologies familiar to those skilled in the art of force measurement. The biomimetic tactile sensor 341 may be a fluid-filled tactile sensor capable of sensing fluid pressure. The fluid pressure in the biomimetic tactile sensor 341 may be used to stabilize contact force by adjusting the position of the linear actuator 330 in the normal axis by means of a feedback controller that maintains the fluid pressure reading at a constant level.

Still referring to FIG. 2A, the one or more linear actuators 330 may be precision components designed to produce smooth motions with high accuracy and repeatability with low mechanical vibration such that the variability and noise of the linear actuators 330 produce variability of tactile properties that is similar to those that would be computed if the linear actuators were not moving. Such precision components may include, but are not limited to, actuators with precision cross roller bearings, actuators with air bearings, actuators with hydraulic cylinders and others familiar to those skilled in the art of mechatronic design. The fidelity of sensor information collected from the biomimetic tactile sensor 341 may benefit from the low background noise levels produced from such precision components as discussed below. An example of a suitable linear actuator 330 may include the ANT95-75-L (Aerotech, Pittsburg, Pa.) or other similar product families. The apparatus may have two linear actuators 330, one to control the movement in the direction normal to the tactile surface 320 and another to control the movement in the direction tangential to the tactile surface 320. However, the actuators need not be linear and alternative technologies such as rotary actuators may be used as familiar to those skilled in the art of mechatronic design.

Referring to FIG. 2B, an additional linear actuator 330 that runs along the length of the gantry 336 may be used. This actuator may permit a single biomimetic tactile sensor 341 to be repositioned to explore multiple tactile surfaces 320. The ability to rapidly change between multiple tactile surfaces 320 may improve the output of the object investigation and classification system 100 when characterizing a large number of objects. This may also benefit from the use of guides to assist the operator with the placement and orientation of the surface in the exploratory range of the machine which may be, but not limited to, laser-generated guides or other indexing tools as familiar to those skilled in the art of industrial equipment design. The ability to change rapidly between multiple tactile surfaces 320 may facilitate comparison between a standardized tactile surface 320 that remains in place as a reference. Alternative configurations to allow for the indexing of multiple samples under the biomimetic tactile sensor 341 may also be possible using technologies such as conveyor belts or sample placement systems familiar to those skilled in the art of mechatronic design.

The configuration with a linear actuator 330 for repositioning as illustrated in FIG. 2B may be used advantageously to perform monitoring or calibration tests upon the biomimetic tactile sensor 341. For example, changes in ambient humidity or temperature may result in changes in the inflation pressure or stiffness of the elastomeric skin of biomimetic tactile sensor 341. In another example, stroking movements on abrasive surfaces may result in wear of the fingerprints molded into the elastomeric skin of the biomimetic tactile sensor 341, which may change the vibration signals that are generated. In order to detect and correct for such changes, the biomimetic tactile sensor 341 may be repositioned over the surface of a conventional optical fingerprint scanner. The vertical linear actuator 330 may then be used to lower the biomimetic tactile sensor 341 until it first touches the surface of the fingerprint scanner, which may be detected by a transient in the fluid pressure sensor and by the appearance of an optically detected contact spot on the surface of the fingerprint scanner. The size of the initial contact spot may tend to vary with the ambient humidity and the cleanliness of the elastomeric skin surface because of van der Waals forces between the two surfaces. As the vertical linear actuator 330 continues to generate calibrated vertical displacements of the biomimetic tactile sensor 341 against the fingerprint scanner, the rate of growth of the contact spot and the rate of increase in the fluid pressure and the rate of increase in forces detected by the force plate may be used as an indicator of the inflation volume of the liquid in the biomimetic tactile sensor 341 and of the stiffness of its elastomeric skin. The image from the optical fingerprint scanner may be analyzed to determine the state of wear of the fingerprints in the elastomeric skin of the biomimetic tactile sensor 341, which may be apparent from the relative size and spacing of the individual fingerprint ridges that make contact with the surface of the fingerprint scanner.

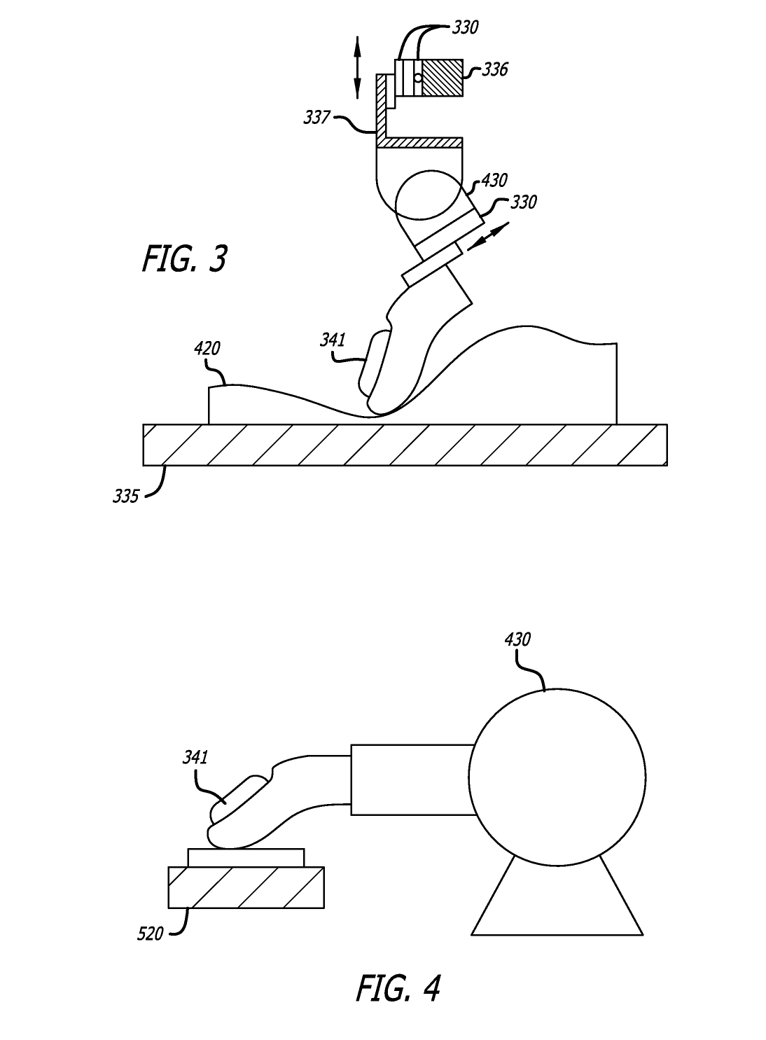

FIG. 3 illustrates an example of the object test system 102 illustrated in FIG. 1 that can explore tactile properties of a contoured tactile surface 420.

Referring to FIG. 3, an object test system 102 that can explore tactile properties of a contoured tactile surface 420 may consist of a base 335, gantry 336, series of linear actuators 330 and rotary actuators 430, and biomimetic tactile sensor 341.

Still referring to FIG. 3, one or more rotary actuators 430 may be used to align the biomimetic tactile sensor 341 so that it is normal to a contoured tactile surface 420. Information from the four electrodes in the tip of the BioTac may be delivered to a feedback controller 150 to control the orientation of the BioTac with respect to the contoured tactile surface 420, as described by (Su, Z, J A Fishel, T Yamamoto, and G E Loeb. 2012. “Use of Tactile Feedback to Control Exploratory Movements to Characterize Object Compliance.” Frontiers in Neurorobotics 6(7): 1-12.), and incorporated herein by reference. Other methods for maintaining constant force while tracking a contoured surface may be possible by computing the reaction forces while sliding the biomimetic tactile sensor 341 over the contoured tactile surface 420 and adjusting the height of the biomimetic tactile sensor 341 and angle of the rotary actuator 430 through the feedback controller 150 such that the normal force between the biomimetic tactile sensor 341 and contoured tactile surface 420 remains constant while also using the rotary actuator 430 to adjust the sliding angle so the combination of translational sliding velocity and lift from the linear actuators 330 maintains a constant contact angle between the biomimetic tactile sensor 341 and contoured tactile surface 420.

Alternatives for maintaining a constant contact force passively while sliding over a contoured tactile surface 420 also exist. For example, if the actuators in the direction of the normal force have passive compliance such as might be found in pneumatic actuators, hydraulic actuators, springs and tendons, the changes in height of the contoured tactile surface 420 may result in passive motion of the biomimetic tactile sensor 341 to maintain a nearly constant contact force. Tendon driven actuators similar to those in the human fingertip that exhibit this type of compliance and force control may be useful for extracting certain tactile properties such as stick-slip chatter that is observed in the human fingertip when sliding over certain types of surfaces, described in more detail below.

Alternatives to improve performance and standardization of measurements from the object investigation and classification system 100 may be pursued. For example, the ambient temperature and humidity may influence the feel of an object 120 under test. Sensors for measuring ambient temperature and humidity, as familiar to those skilled in the art of temperature and humidity measurement, may also be included in the object test system 102 as a reference point to ensure appropriate tests are performed under desired testing conditions before starting a measurement or they may be used to calibrate tactile property measurements by adjusting the analytical functions 160 to compensate for changes in temperature and humidity. If it is desired to modulate temperature and humidity to evaluate how the feel of the object 120 under test changes in response to these parameters, the object test system 102, may be encased in an environmental chamber designed to control temperature and humidity as familiar to those skilled in the art of building environmental control chambers.

The object test system 102 may be equipped with additional mechatronics to permit the automated presentation of multiple objects 120 to the object test system 102, as familiar to those skilled in the art of automated material handling. One approach to accomplish this may be to use a conveyor belt to move objects 120 under the object test system 102. For objects 120 that possess anisotropy an additional actuator designed to rotate the biomimetic tactile sensor 341 or object 120 may be used to control the alignment between these two components prior to testing.

FIG. 4 illustrates an example of the object test system 102 illustrated in FIG. 1 that can explore tactile properties of a pushbutton 520.

Referring to FIG. 4, an object test system 102 that can explore the tactile properties of a pushbutton 520 may consist of a biomimetic tactile sensor 341 that can be pressed on a pushbutton 520 using a rotary actuator 430. The rotary actuator 430 may be any type of actuator designed to produce vertical force and motion of the biomimetic tactile sensor 341 on the pushbutton 520, such as, but not limited to, a brushless DC motor or any other type of actuator as familiar to those skilled in the arts of mechanical actuation. It may be desirable that the rotary actuator 430 exhibits similar properties as the musculoskeletal system of the human fingertip such that it may be force controlled and possesses some compliance. Alternative methods to create such compliance may be used with tendons that have spring-like properties that are similar to the tendons in the human fingertip, such as, but not limited to, mechanical properties that are possible with series elastic actuators (Pratt, G. and Williamson, M M. “Series elastic actuators.” In Intelligent Robots and Systems Proceedings, Vol. 1 pp 399-406, IEEE).

### Recall and Display System

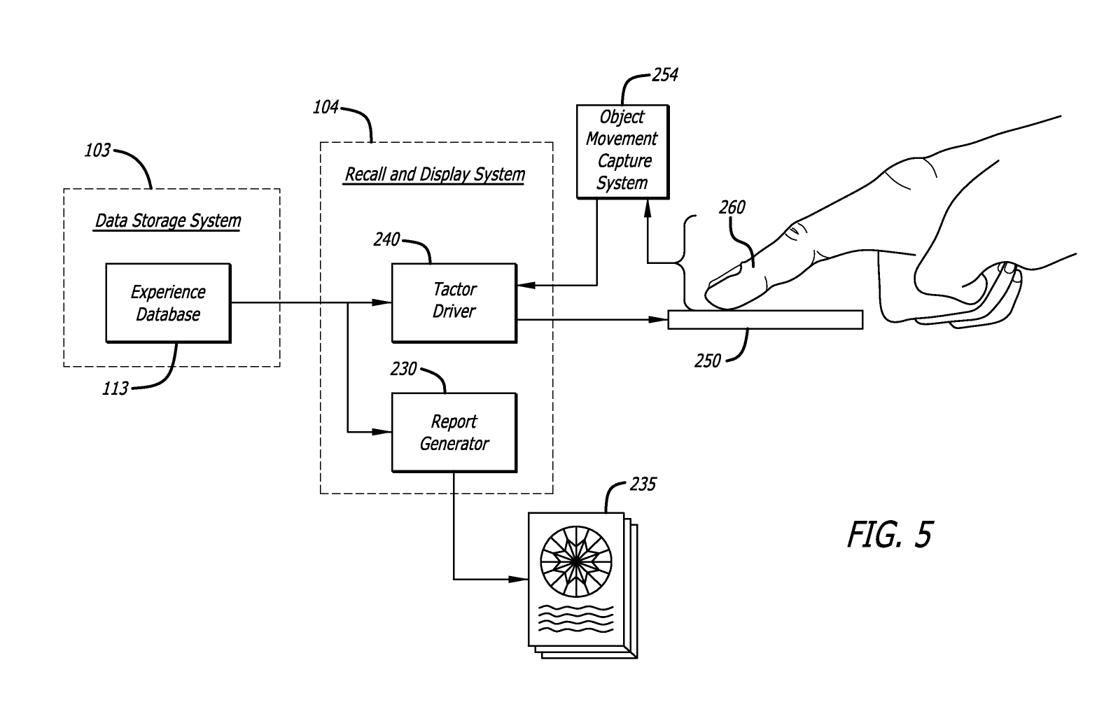

FIG. 5 illustrates an example of the recall and display system illustrated in FIG. 1 that can generate reports about collected objects or simulate an object on a tactile display.

Referring to FIG. 5, a recall and display system to present data from the experience database 113 to a human operator may include a data storage system 103 and a recall and display system 104.

Still referring to FIG. 5, information from the experience database 113 may be used by the recall and display system 104 to deliver human-interpretable information about its contents. Information in the experience database 113 about one or more previously explored objects can be processed by a report generator 230 to deliver a report 235 that contains information about the tactile properties obtained from the one or more previously explored objects. Information in the report 235 may be organized in tabular forms to indicate tactile properties for each test on each object, or may be simplified as descriptive statistics including means and standard deviations or other techniques familiar to those skilled in the arts of descriptive statistics. Information in the report 235 may also be illustrated graphically in plots that indicate the measurements, means and or standard deviations of one or more tactile properties for one or more previously measured objects. All of the tactile properties for any given object in the experience database 113 may be illustrated in a single “spider plot” (so-called because of its visual similarity to a spider's web) and multiple entries may be overlaid on the same spider plot for comparison. Advantageously, such a spider plot may be organized so that the most closely related tactile properties are adjacent to each other, which may facilitate comparisons among objects that may reflect linguistic tactile descriptors.

Still referring to FIG. 5, the recall and display system may contain a tactor driver 240 to drive a tactor 250 that provides a virtual sensory experience to a human operator by applying forces, vibrations, temperature changes or other stimuli to a human fingertip 260. The stimuli may cause the human operator to perceive that he/she is touching an object whose tactile properties have been recorded in the experience database 113. An operator movement capture system 254 may be used to capture the movement of the human fingertip 260 and deliver this information to the tactor driver 240 to allow it to produce appropriate commands to the tactor 250 to produce relevant stimulation on the human fingertip 260 and reproduce the feel of an object with high fidelity and appropriate timing. Several technologies for providing such stimulation with a tactor 250 exist. The tactor may include voice-coil based vibrator elements such as the Haptuator (Tactile Labs) to vibrate the human fingertip with a modulated amplitude and frequency so they can be readily sensed by the human fingertip 260. The tactor 250 may include eccentric motors such as the vibrators found on commercial cellular phones to control the amplitude of vibration. The tactor 250 may include heating elements such as a Peltier element to heat or cool the human fingertip 260. The tactor 250 may contain actuators to move the tactor surface up and down and/or tangentially. The tactor 250 may contain an electrostatic display or an ultrasonic display to modulate the friction of the surface by either pulling the human fingertip into the surface or creating a squeeze film of air respectively. The tactor 250 may make circular movements while modulating the friction of the surface to create the illusion of tangential forces on the human fingertip. The tactor 250 may change the shape of the surface of the display.

Still referring to FIG. 5, an operator movement capture system 254 may be used to capture the movement and forces of the human fingertip 260 on the tactor 250 such that the tactor driver 240 can provide appropriate stimulation to the human fingertip 260 to create the sensation that the human fingertip 260 is touching an object from the experience database 113. Several technologies exist to enable the operator movement capture system 254. Force plates on the tactor 250 may be used to determine the normal and tangential force being applied by the human fingertip 260 on the tactor. A 6-axis load cell may also be used to compute the normal and tangential forces as well as the point of contact, which could then be used to determine velocity as familiar to those skilled in using 6-axis load cells. To provide a more accurate measurement of the contact position and movement velocity the tactor 250 could be equipped with a capacitive display similar to those phone in touch-screen cellular phones. Motion capture systems that use various detection methods including video image analysis, reflected light trackers, emitted light trackers, ultrasonic transmission time, and other technologies well-known in the art may also be used for the operator movement capture system 254 to localize the position and movement of the human fingertip 260.

### Tactile Property Calculations and Tactor Display

The signal processing strategies for the measurement of tactile properties that correspond to the linguistic tactile descriptors employed by humans when describing the feel of objects may be computed from the sensory information obtained from the biomimetic tactile sensor 341 and/or from other sensors, such as position encoders, strain gauges, motor current sensors, force plates, or other technologies familiar to those skilled in the art of mechatronic instrumentation. Examples of linguistic tactile descriptors for surfaces observed by humans may include, but are not limited to: properties relating to surface texture including, but not limited, to microtexture roughness, macrotexture roughness, microtexture coarseness, macrotexture coarseness, or macrotexture regularity; properties related to friction, including, but not limited to, tactile stiction, tactile sliding resistance, or tactile stick slip chatter; properties relating to compliance, including, but not limited to, tactile compliance, tactile deformability, tactile damping, tactile relaxation, or tactile yielding; properties relating to thermal properties, including, but not limited to thermal cooling or thermal persistence; and/or properties related to adhesion, including, but not limited to adhesiveness. Examples of linguistic tactile descriptors for active objects, such as pushbuttons may include, but are not limited to: contact rattle, actuation force, click intensity, travel, deactivation click intensity, and lateral rattle.

The biologically inspired strategies described above for using humanlike exploratory movements and biomimetic tactile sensors 341 to capture sensory information in a manner similar to how human fingertips would otherwise receive this sensory information and using analytical functions 160 to compute tactile properties may be essential for reversing this process to use a tactile property to determine how a tactor driver 240 may drive a tactor 250 based on information captured by the operator movement capture system 254. The verisimilitude of the tactor output for a simulated object may be evaluated by using tactor 250 in place of the object 120 in an object test system 102, whereby the tactor 250 has been configured to simulate the properties of the object 120, and comparing the tactile properties obtained from the tactor 250 simulating the object 120 to those of the tactile properties obtained directly from the object 120.

### Object Tactile Properties

### Macrotexture Roughness

Macrotexture roughness may be derived from the amplitude of vibrations that naturally occur due to relative sliding between the biomimetic tactile sensor 341 and the object 120. The vibrations are caused by structural features that can be of various heights on the object 120, but have a spatial wavelength that may be larger than the spacing between neighboring human fingerprint ridges, i.e., larger than about 0.3 mm. Other thresholds may be possible and the minimum spatial wavelength for a macrotexture feature may be between 0.2-2 mm. In the human fingertip when sliding with velocities between 0.5-10 cm/s, these vibrations, which are highly dependent on the complex interactions between the fingerprints and object 120, can be between 5-100 Hz and may be captured by Meissner corpuscles in the skin that may be responsible for perceiving vibrations in these frequency ranges. To elicit these vibrations from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the macrotexture roughness may be computed by an analytical function 160 that determines a measure of vibrational intensity in a frequency band that is within 5-100 Hz as detected by the biomimetic tactile sensor. For example, the macrotexture roughness may be computed by determining the logarithm of variance in the time-dependent vibration signal measured by the biomimetic tactile sensor 341 while sliding at a constant velocity. Other methods to derive a measurement value that correlates to the vibrational signal power in this frequency bandwidth may be possible, such as, but not limited to, using discrete Fourier transforms to compute vibration power, computing the amplitude of vibrations, as well as other methods familiar to those skilled in the art of signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of macrotexture roughness may be averaged to improve measurement accuracy. Other humanlike exploratory movement sequences to elicit these vibrations may be used. For example, a standardized velocity profile that is not constant velocity may be used to elicit these vibrations. In another example, the contact force may be intentionally varied to actively maximize the power of the vibration signals.

To simulate this tactile property with a tactor 250, the operator movement capture system 254 may determine the contact force and sliding speed and compute a corresponding vibration power in the frequency band of 5-100 Hz to stimulate the human fingertip 260. The exact frequency that is used to convey this vibration power may be determined from the macrotexture coarseness tactile property as described below. This vibration power may be computed by inverting the analytical function 160, as familiar to one skilled in the art of manipulating mathematical equations, that was used to determine the tactile property value.

### Microtexture Roughness

Microtexture roughness may be derived from the amplitude of vibrations that naturally occur due to relative sliding between the biomimetic tactile sensor 341 and the object 120. The vibrations are caused by structural features that can be of various heights on the object 120, but have a spatial wavelength that is smaller than the spacing between neighboring human fingerprint ridges, i.e., smaller than about 0.3 mm. Other thresholds may be possible and the maximum spatial wavelength for a microtexture feature may be between 0.2-2 mm. In the human fingertip when sliding with velocities between 0.5-10 cm/s, these vibrations, which are highly dependent on the complex interactions between the fingerprints and object 120, can be between 20-800 Hz and may be captured by Pacinian corpuscles in the skin that may be responsible for perceiving vibrations in these frequency ranges. To elicit these vibrations from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the microtexture roughness may be computed by an analytical function 160 that determines a measure of vibrational intensity in a frequency band that is within 20-800 Hz as detected by the biomimetic tactile sensor. For example, the microtexture roughness may be computed by determining the logarithm of variance in the time-dependent vibration signal measured by the biomimetic tactile sensor 341 while sliding at a constant velocity. Other methods to derive a measurement value that correlates to the vibrational signal power in this frequency bandwidth may be possible, such as, but not limited to, using discrete Fourier transforms to compute vibration power, computing the amplitude of vibrations, as well as other methods familiar to those skilled in the art of signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of microtexture roughness may be averaged to improve measurement accuracy. Other humanlike exploratory movement sequences to elicit these vibrations may be used. For example, a standardized velocity profile that is not constant velocity may be used to elicit these vibrations. In another example, the contact force may be intentionally varied to actively maximize the power of the vibration signals.

To simulate this tactile property with a tactor 250, the operator movement capture system 254 may determine the contact force and sliding speed and compute a corresponding vibration power in the frequency band of 20-800 Hz to stimulate the human fingertip 260. The exact frequency that is used to convey this vibration power may be determined from the microtexture coarseness tactile property as described below. This vibration power may be computed by inverting the analytical function 160, as familiar to one skilled in the art of manipulating mathematical equations, that was used to determine the tactile property value.

### Macrotexture Coarseness

Macrotexture coarseness may be derived from the frequency of vibrations that naturally occur due to relative sliding between the biomimetic tactile sensor 341 and the object 120. The vibrations are caused by structural features that can be of various spatial wavelengths on the object 120, but have a spatial wavelength that is larger than the spacing between neighboring human fingerprint ridges, i.e., larger than about 0.3 mm. Other thresholds may be possible and the minimum spatial wavelength for a macrotexture feature may be between 0.2-2 mm. In the human fingertip when sliding with velocities between 0.5-10 cm/s, these vibrations, which are highly dependent on the complex interactions between the fingerprints and object 120, can be between 5-100 Hz and may be captured by Meissner corpuscles in the skin that may be responsible for perceiving vibrations in these frequency ranges. To elicit these vibrations from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the macrotexture coarseness may be computed by an analytical function 160 that determines a measure of vibration frequency in a frequency band that is within 5-100 Hz as detected by the biomimetic tactile sensor. For example, the macrotexture coarseness may be computed from the spectral centroid by first computing a discrete Fourier transform of the vibration time signal, squaring the magnitude of each bin in the discrete Fourier transform of the vibration time signal to determine power, weighting each bin by multiplying it by its respective frequency, summing all of the components, and dividing that sum by the sum of all squared discrete Fourier transform bins to determine its central frequency. The sliding speed may then be divided by this central frequency to determine the average spatial frequency. The average spatial frequency may be placed on a logarithmic scale to determine macrotexture coarseness. Other methods to derive a measurement value that correlates to the vibration frequency in this frequency bandwidth may be possible, such as, but not limited to, counting the number of times a vibration signal crosses a given threshold in a given period of time, identifying the component in a discrete Fourier transform that contains the most signal power, as well as other methods familiar to those skilled in the art of signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of macrotexture coarseness may be averaged to improve measurement accuracy. Other humanlike exploratory movement sequences to elicit these vibrations may be used. For example, a standardized velocity profile that is not constant velocity may be used to elicit these vibrations. In another example, the contact force may be intentionally varied to actively maximize the power of the vibration signals.

To simulate this tactile property with a tactor 250, the operator movement capture system 254 may determine the contact force and sliding speed and compute a corresponding vibration frequency to stimulate the human fingertip 260. The exact amplitude of the frequency that is used may be determined from the macrotexture roughness tactile property as described above. This frequency may be computed by inverting the analytical function 160, as familiar to one skilled in the art of manipulating mathematical equations, that was used to determine the tactile property value.

### Microtexture Coarseness

Microtexture coarseness may be derived from the frequency of vibrations that naturally occur due to relative sliding between the biomimetic tactile sensor 341 and the object 120. The vibrations are caused by structural features that can be of various spatial wavelengths on the object 120, but have a spatial wavelength that is smaller than the spacing between neighboring human fingerprint ridges, i.e., smaller than about 0.3 mm. Other thresholds may be possible and the maximum spatial wavelength for a microtexture feature may be between 0.2-2 mm. In the human fingertip when sliding with velocities between 0.5-10 cm/s, these vibrations, which are highly dependent on the complex interactions between the fingerprints and object 120, can be between 20-800 Hz and may be captured by Pacinian corpuscles in the skin that may be responsible for perceiving vibrations in these frequency ranges. To elicit these vibrations from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the microtexture coarseness may be computed by an analytical function 160 that determines a measure of vibration frequency in a frequency band that is within 20-800 Hz as detected by the biomimetic tactile sensor. For example, the microtexture coarseness may be computed from the spectral centriod by first computing a discrete Fourier transform of the vibration time signal, squaring the magnitude of each bin in the discrete Fourier transform of the vibration time signal to determine power, weighting each bin by multiplying it by its respective frequency, summing all of the components, and dividing that sum by the sum of all squared discrete Fourier transform bins to determine its central frequency. The sliding speed may then be divided by this central frequency to determine the average spatial frequency. The average spatial frequency may be placed on a logarithmic scale to determine microtexture coarseness. Other methods to derive a measurement value that correlates to the vibration frequency in this frequency bandwidth may be possible, such as, but not limited to, counting the number of times a vibration signal crosses a given threshold in a given period of time, identifying a the component in a discrete Fourier transform that contains the most signal power, as well as other methods familiar to those skilled in the art of signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of microtexture coarseness may be averaged to improve measurement accuracy. Other humanlike exploratory movement sequences to elicit these vibrations may be used. For example, a standardized velocity profile that is not constant velocity may be used to elicit these vibrations. In another example, the contact force may be intentionally varied to actively maximize the power of the vibration signals.

To simulate this tactile property with a tactor 250, the operator movement capture system 254 may determine the contact force and sliding speed and compute a corresponding vibration frequency to stimulate the human fingertip 260. The exact amplitude of the frequency that is used may be determined from the microtexture roughness tactile property as described above. This frequency may be computed by inverting the analytical function 160, as familiar to one skilled in the art of manipulating mathematical equations, that was used to determine the tactile property value.

### Macrotexture Regularity

Macrotexture regularity may be derived from the degree to which macrotexture features repeat periodically rather than randomly based on vibrations that naturally occur due to relative sliding between the biomimetic tactile sensor 341 and the object 120. The vibrations are caused by structural features that can be of various heights on the object 120, but have a spatial wavelength that is larger than the spacing between neighboring human fingerprint ridges, i.e., larger than about 0.3 mm. Other thresholds may be possible and the minimum spatial wavelength for a macrotexture feature may be between 0.2-2 mm. In the human fingertip when sliding with velocities between 0.5-10 cm/s, these vibrations, which are highly dependent on the complex interactions between the fingerprints and object 120, can be between 5-100 Hz and may be captured by Meissner corpuscles in the skin that may be responsible for perceiving vibrations in these frequency ranges. To elicit these vibrations from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the macrotexture regularity may be computed by an analytical function 160 that determines a measure of the distribution of vibrational frequency content in a frequency band that is within 5-100 Hz. For example, the macrotexture regularity may be computed by determining the diffuseness of power in a discrete Fourier transform of the time-dependent vibration signal measured by the biomimetic tactile sensor 341 while sliding at a constant velocity. In this example, the discrete Fourier transform may be computed and the components of one or more frequency bins containing the most signal power may be divided by the total signal power to determine the ratio of signal power contained within these one or more frequency bins. The computed value may be placed on a log scale to compute macrotexture regularity. Other methods to derive a measurement value that correlates to the distribution of vibration frequency content in this frequency bandwidth may be possible, such as, but not limited to, the ratio of power in the top discrete Fourier transform bin to the total signal power of the vibration signal, the total harmonic distortion of the vibration signal, as well as other methods familiar to those skilled in the art of signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of macrotexture regularity may be averaged to improve measurement accuracy. Other humanlike exploratory movement sequences to elicit these vibrations may be used. For example, a standardized velocity profile that is not constant velocity may be used to elicit these vibrations. In another example, the contact force may be intentionally varied to actively maximize the power of the vibration signals.

To simulate this tactile property with a tactor 250, the operator movement capture system 254 may determine the contact force and sliding speed and compute a corresponding degree in which the central frequency may be distributed when stimulating the human fingertip 260 with vibration. For example, one method may be to apply a frequency modulation around the central frequency to simulate the diffuseness of the frequency, the degree of frequency modulation may correlate with the macrotexture regularity. The exact frequency that this is centered on may be determined from the macrotexture coarseness tactile property as described above. This amplitude may be computed by inverting the analytical function 160, as familiar to one skilled in the art of manipulating mathematical equations that was used to determine the tactile property value.

### Tactile Stiction

Tactile stiction may be derived from the degree of maximum tangential force that naturally occurs at the transition from rest to sliding between the biomimetic tactile sensor 341 and the object 120. The resistive forces may be caused by static friction that may be overcome between the biomimetic tactile sensor 341 and the object 120 as the relative motion transitions from rest to sliding. In the human fingertip when sliding with velocities between 0.5-10 cm/s, these tangential forces, which may be highly dependent on contact forces, static friction and the compliant properties of the human fingertip and object 120, may be many times larger than the contact force in the normal direction and may be captured by Ruffini endings in the skin that may be responsible for perceiving tangential forces applied to the fingertip through skin stretch. To elicit these tangential forces from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the tactile stiction may be computed by an analytical function 160 that determines a measure of peak tangential force as the relative position of the biomimetic tactile sensor 341 and the object 120 transition from rest to sliding as detected by the biomimetic tactile sensor 341 or other instrumentation such as a load cell. Even if the biomimetic tactile sensor 341 is not used to measure these tangential forces, its compliant geometry may be highly influential in the development of these tangential forces. For example, the tactile stiction may be computed by determining the peak tangential force between the biomimetic tactile sensor 341 and object 120 as measured by a load cell as movement begins. This value may be normalized by dividing by the contact force in the normal direction. In another example, the peak tangential force may be computed from measurements of skin stretch in the biomimetic tactile sensor 341. In this example, if the biomimetic tactile sensor 341 is the BioTac (SynTouch, Los Angeles, Calif.) tangential force may be measured by changes in electrodes that rest on the lateral edges of the BioTac sensor (Lin, C. H., Fishel, J. A., and Loeb, G. E., 2013, ” Estimating point of contact, force and torque in a biomimetic tactile sensor with deformable skin”, SynTouch LLC.). In another example, if the biomimetic tactile sensor 341 is the BioTac (SynTouch, Los Angeles, Calif.), tangential force may be measured using neural networks (Wettels, N. and Loeb, G. E., 2011, “Haptic feature extraction from a biomimetic tactile sensor: force, contact location and curvature”, IEEE International Conference on Robotics and Biomimetics, 2471-2478.). Other methods for measuring tangential force may be used as familiar to those skilled in the art of instrumentation and signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of tactile stiction may be averaged to improve measurement accuracy. Other humanlike exploratory movement sequences to elicit these tangential forces may be used. For example, a standardized velocity profile that is not constant velocity may be used to elicit these forces, different rates of acceleration may be used at the start of sliding that may be within, but not limited to, 0.1 cm/s² to 10 cm/s².

To simulate this tactile property with a tactor 250, the operator movement capture system 254 may determine the contact force and compute a corresponding resistive force to stimulate the human fingertip 260 prior to sliding which may be determined by the operator movement capture system 254. Various methods for modulating friction forces in a tactor 250 are described above.

### Tactile Sliding Resistance

Tactile sliding resistance may be derived from the degree of tangential force that naturally occurs after the relative motion between the biomimetic tactile sensor 341 and the object 120 have transitioned to sliding. The tangential forces may be caused by kinetic friction between the biomimetic tactile sensor 341 and the object 120. In the human fingertip when sliding with velocities between 0.5-10 cm/s, these tangential forces, which may be highly dependent on contact forces, kinetic friction and compliant geometry of the human fingertip and object 120, may be many times larger than the contact force in the normal direction and may be captured by Ruffini endings in the skin that may be responsible for perceiving tangential forces applied to the fingertip through skin stretch. To elicit these tangential forces from the relative sliding between the biomimetic tactile sensor 341 and the object 120 so they may be sensed by a biomimetic tactile sensor 341, sliding movements may be used with forces that may be in, but not limited to, the range of 0.2-2N of force and sliding velocities that may be in, but not limited to, the range of 0.5-10 cm/s. The value of the tactile sliding resistance may be computed by an analytical function 160 that determines a measure of tangential force as the biomimetic tactile sensor 341 slides over the object 120 as detected by the biomimetic tactile sensor 341 or other instrumentation such as a load cell. Even if the biomimetic tactile sensor 341 is not used to measure these tangential forces, its compliant geometry may be highly influential in the development of these tangential forces. For example, the tactile sliding resistance may be computed by determining the average tangential force between the biomimetic tactile sensor 341 and object 120 as measured by a load cell after the relative motion has transitioned to sliding. This value may be normalized by dividing by the contact force in the normal direction. In another example, the tangential force may be computed from measurements of skin stretch in the biomimetic tactile sensor 341. In this example, if the biomimetic tactile sensor 341 is the BioTac (SynTouch, Los Angeles, Calif.) tangential force may be measured by changes in electrodes that rest on the lateral edges of the BioTac sensor (Lin, C. H., Fishel, J. A., and Loeb, G. E., 2013, “Estimating point of contact, force and torque in a biomimetic tactile sensor with deformable skin”, SynTouch LLC.). In another example, if the biomimetic tactile sensor 341 is the BioTac (SynTouch, Los Angeles, Calif.), tangential force may be measured using neural networks (Wettels, N. and Loeb, G. E., 2011, “Haptic feature extraction from a biomimetic tactile sensor: force, contact location and curvature”, IEEE International Conference on Robotics and Biomimetics, 2471-2478.). Other methods for measuring tangential force may be used as familiar to those skilled in the art of instrumentation and signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of tactile sliding resistance may be averaged to improve measurement accuracy. Other humanlike exploratory movement sequences to elicit these tangential forces may be used. For example, a standardized velocity profile that is not constant velocity may be used to elicit these forces.

To simulate this tactile property with a tactor 250, the operator movement capture system 254 may determine the contact force and compute a corresponding resistive force to stimulate the human fingertip 260 after sliding which may be determined by the operator movement capture system 254. Various methods for modulating friction forces in a tactor 250 are described above.

### Tactile Stick Slip Chatter

Tactile stick slip chatter may be derived from the variation in tangential force that naturally occurs after the relative motion between the biomimetic tactile sensor 341 and the object 120 if the object 120 and biomimetic tactile sensor 341 have properties that are favorable to elicit the stick-slip phenomenon which may occur if there are large enough differences between static and kinetic friction combined with elasticity in the sliding direction. The stick slip phenomenon is classified by rapid changes between sticking and sliding when a relative sliding velocity is imposed between two surfaces. In the human fingertip when sliding with velocities between 0.5-10 cm/s with forces between 0.2-2N, this phenomenon may occur causing rapid changes in tangential force, which may be highly dependent on contact forces, static friction, kinetic friction, compliant geometry of the human fingertip and the object 120, and compliance in the actuation system. The transient peaks of tangential force may be many times larger than the contact force in the normal direction and may be captured by Ruffini endings in the skin that may be responsible for perceiving tangential forces applied to the fingertip through skin stretch as well as Meissner corpuscles that may be responsible for perceiving vibrations between 5-100 Hz. To elicit these tangential forces from the relative sliding between the biomimetic tactile sensor 341 and the object 120 so they may be sensed by biomimetic tactile sensor 341, sliding movements may be used with forces that may be in, but not limited to, the range of 0.2-2N of force and sliding velocities that may be in, but not limited to, the range of 0.5-10 cm/s. Contact force may be dynamically modified to elicit the stick-slip phenomenon. Adding elasticity in the actuators may improve the ability to elicit this phenomenon. The value of the tactile stick slip chatter may be computed by an analytical function 160 that determines a measure of the variation of tangential force as the biomimetic tactile sensor 341 slides over the object 120 as detected by the biomimetic tactile sensor 341 or other instrumentation such as a load cell. Alternatively, the value of the tactile stick slip chatter may be computed by an analytical function 160 that determines a measure of the variation of friction coefficient as computed by the ratio of tangential to normal force as the biomimetic tactile sensor 341 slides over the object 120 as detected by the biomimetic tactile sensor 341 or other instrumentation such as a load cell. The biomimetic tactile sensor 341 may be used to measure vibrations that occur from this phenomenon and other instrumentation such as a force plate may be used to sense variations in either the tangential force or friction coefficient while sliding. In another example, the tangential and/or normal force may be computed from measurements of skin stretch in the biomimetic tactile sensor 341. In this example, if the biomimetic tactile sensor 341 is the BioTac (SynTouch, Los Angeles, Calif.) tangential force may be measured by changes in electrodes that rest on the lateral edges of the BioTac sensor and/or normal force may be measured by changes in electrodes at the contact location of the BioTac sensor (Lin, C. H., Fishel, J. A., and Loeb, G. E., 2013, “ Estimating point of contact, force and torque in a biomimetic tactile sensor with deformable skin”, SynTouch LLC.). In another example, if the biomimetic tactile sensor 341 is the BioTac (SynTouch, Los Angeles, Calif.), tangential and/or normal force may be measured using neural networks (Wettels, N. and Loeb, G. E., 2011, “Haptic feature extraction from a biomimetic tactile sensor: force, contact location and curvature”, IEEE International Conference on Robotics and Biomimetics, 2471-2478.). Other methods for measuring tangential and/or normal force may be used as familiar to those skilled in the art of instrumentation and signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Variations may exist for different combinations of force and velocity on a given object 120. Multiple sliding movements may be repeated and the resulting computations of tactile stick slip chatter resistance may be averaged to improve measurement accuracy. Other humanlike exploratory movement sequences to elicit these variations in tangential force may be used. For example, a standardized velocity profile that is not constant velocity may be used to elicit these forces and the peak variation in the ratio of tangential to normal force may be used to compute this property. In yet another example, a contact force may be varied over the sliding movement and the peak variation in the ratio of tangential to normal force may be used to compute this property. In yet another example, alternative methods to derive a measurement value that correlates to the variation in the ratio of tangential to normal force may be used, as familiar to those skilled in the art of signal processing.

To simulate this tactile property with a tactor 250, the operator movement capture system 254 may determine the contact force and compute a corresponding variation in resistive tangential force to stimulate the human fingertip 260 after sliding which may be determined by the operator movement capture system 254. This variation may modulate around or above the tangential force used from the tactile sliding resistance described above. Various methods for modulating friction forces in a tactor 250 are described above.

### Tactile Compliance

Tactile compliance may be derived from the ratio of displacement to normal force that naturally occurs between the biomimetic tactile sensor 341 and the object 120 as they come into contact under force. The displacement at a given force may be caused by combined compliance of the biomimetic tactile sensor 341 and the object 120. In the human fingertip and tendon structure, local deformations in the skin may be captured by Merkel discs while larger displacements may be captured by the muscle spindles in the muscles and tendons driving the finger. To elicit these deformations from the relative motion between the biomimetic tactile sensor 341 and the object 120 so they may be sensed by a biomimetic tactile sensor 341 and sensory instrumentation, contact forces may be applied by the biomimetic tactile sensor 341 onto the object 120 that may be in, but not limited to, the range of 0.2-15N of force. The value of the tactile compliance may be computed by an analytical function 160 that determines a measure of the ratio of displacement to normal force at the maximum contact force. In another example the measurement of displacement may be compensated by the deformation of the biomimetic tactile sensor 341, which may have a known displacement at a given load. Actuator displacement may be sensed using position encoders which may be optical, magnetic, ultrasonic, or any other technology suitable for measuring displacement as familiar to those skilled in the arts of mechanical instrumentation. The normal force may be detected by the biomimetic tactile sensor 341 or other instrumentation such as a load cell. In another example the normal force may be computed from measurements of skin deformation in biomimetic tactile sensor 341 as described above. Other methods for measuring normal force may be used as familiar to those skilled in the art of instrumentation and signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force. Multiple pushing movements may be repeated and the resulting computations of tactile property may be averaged to improve measurement accuracy.

To simulate this tactile property with a tactor 250, the operator movement capture system 254 may determine the contact force and compute a corresponding displacement in the tactor 250 which may be applied by moving the tactor 250 away from the fingertip in response to this force. This movement may be implemented with actuators that move the tactor 250. This movement may be designed to compensate for deformations in the human fingertip 260 as it pushes on the tactor 250, which may be possible if the deformation properties of the human fingertip 260 are known.

### Tactile Deformability

Tactile deformability may be derived from the local deformation that naturally occurs in the biomimetic tactile sensor 341 when pushing into the object 120 under force. Objects 120 that are highly deformable may have a tendency to wrap around the biomimetic tactile sensor 341 as it pushes into the object. The degree that the surface wraps around the biomimetic tactile sensor 341 at a given force may be caused by combined deformability of the biomimetic tactile sensor 341 and the object 120. In the human fingertip, local deformations in the skin may be captured by Merkel discs. To elicit these deformations from the relative motion between the biomimetic tactile sensor 341 and the object 120 so they may be sensed by a biomimetic tactile sensor 341 and sensory instrumentation, contact forces may be applied by the biomimetic tactile sensor 341 onto the object 120 that may be in, but not limited to, the range of 0.2-15N of force. The value of the tactile deformability may be computed by an analytical function 160 that determines a measure of the local deformation in the biomimetic tactile sensor 341. For example, if the biomimetic tactile sensor 341 is filled with fluid and convex in shape, the increase in fluid pressure of the biomimetic tactile sensor may relate to a measure of the local deformation in the biomimetic tactile sensor 341. Alternatively, if the biomimetic tactile sensor 341 is convex like the human fingertip and capable of sensing distributions in normal force, tactile deformability may be computed by the gradient of contact forces away from the center of contact. A biomimetic tactile sensor 341 such as the BioTac (SynTouch, Los Angeles, Calif.) is an example of a biomimetic tactile sensor 341 capable of performing these measurements. Other methods for measuring normal force may be used as familiar to those skilled in the art of instrumentation and signal processing. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force. Multiple pushing movements may be repeated and the resulting computations of tactile property may be averaged to improve measurement accuracy.

To simulate this tactile property with a tactor 250, the operator movement capture system 254 may determine the contact force and compute a corresponding deformability in the tactor 250 which may be applied by moving the tactor 250 so that it presses on the lateral sides of the fingertip in response to this force. This movement may be implemented with actuators that move the tactor 250.

### Tactile Damping

Tactile damping may be derived from the forces and time-dependent displacement that naturally occur between the biomimetic tactile sensor 341 and the object 120 as they come into contact under force. The displacement at a given force may be caused by combined viscoelastic compliance of the biomimetic tactile sensor 341 and the object 120. In the human fingertip and tendon structure, local deformations in the skin may be captured by Merkel discs while larger displacements may be captured by the muscle spindles in the muscles and tendons driving the finger. To elicit these time-dependent deformations from the relative motion between the biomimetic tactile sensor 341 and the object 120 so they may be sensed by a biomimetic tactile sensor 341 and sensory instrumentation, contact forces may be applied by the biomimetic tactile sensor 341 onto the object 120 that may be in, but not limited to, the range of 0.2-15N of force then the force between the biomimetic tactile sensor 341 and object 120 may be reduced while maintaining contact such that the biomimetic tactile sensor 341 may rise back up. Contact forces may be increased gradually with time constants between 0.1-1s to evaluate viscoelastic effects. The value of the tactile damping may be computed by an analytical function 160 that determines a measure of the ratio of energy recovered when lifting to the energy required to compress the object. For example, the energy to compress the biomimetic tactile sensor 341 into the object may be computed by the integral of the contact force vs. total displacement while increasing force, the energy recovered from releasing contact force may also be computed from the integral of the contact force vs total displacement while decreasing force. The ratio of energy recovered to energy to compress may be used to compute tactile damping. Other methods for computing damping may exist as are familiar to those skilled in the art of evaluating hysteresis. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force or rates of force loading. Multiple pushing movements may be repeated and the resulting computations of tactile damping may be averaged to improve measurement accuracy.

To simulate this tactile property with a tactor 250, the operator movement capture system 254 may determine the contact force and compute a corresponding displacement in the tactor 250 which may be applied by moving the tactor 250 away from the fingertip in response to this force. This movement may be implemented with actuators that move the tactor 250. When the operator movement capture system 254 detects a decrease in contact force, the tactor may move the surface back upwards to ensure the appropriate amount of energy is released back into the finger based on the value of tactile damping.

### Tactile Relaxation

Tactile relaxation may be derived from the time-dependent reaction forces that naturally occur between the biomimetic tactile sensor 341 and the object 120 as they come into contact under force. The reaction forces as a function of time at a fixed displacement may be caused by combined viscoelastic compliance of the biomimetic tactile sensor 341 and the object 120. In the human fingertip and tendon structure, forces in the skin may be captured by Merkel discs while larger forces may be captured by the Golgi tendon organs in the muscles and tendons driving the finger. To elicit these time-dependent reaction forces from the relative motion between the biomimetic tactile sensor 341 and the object 120 so they may be sensed by a biomimetic tactile sensor 341 and sensory instrumentation, contact forces may be applied by the biomimetic tactile sensor 341 onto the object 120 that may be in, but not limited to, the range of 0.2-15N of force then the biomimetic tactile sensor 341 may be held in place while observing how these forces change over time. Contact forces may be increased gradually with time constants between 0.1-1s to evaluate viscoelastic effects. The value of the tactile relaxation may be computed by an analytical function 160 that determines a measure of the change in the normal force while the biomimetic tactile sensor 341 is held in place. For example, the ratio of force after a fixed period of time to the initial force at the start of the hold. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force or rates of force loading. Multiple pushing movements may be repeated and the resulting computations of tactile relaxation may be averaged to improve measurement accuracy.

To simulate this tactile property with a tactor 250, the operator movement capture system 254 may determine the contact force and compute a corresponding displacement in the tactor 250 which may be applied by moving the tactor 250 away from the fingertip in response to this force. When holding this force, the tactor may be gradually moved away to simulate the reduced forces from tactile relaxation. This movement may be implemented with actuators that move the tactor 250.

### Tactile Yielding

Tactile yielding may be derived from the degree of displacement recovered when removing contact forces that naturally occur between the biomimetic tactile sensor 341 and the object 120 as they come into contact under force and are released. The displacement at a given force and recovery may be caused by combined viscoelastic compliance of the biomimetic tactile sensor 341 and the object 120. In the human fingertip and tendon structure, local deformations in the skin may be captured by Merkel discs while larger displacements may be captured by the muscle spindles in the muscles and tendons driving the finger. To elicit these time-dependent restorative movements from the relative motion between the biomimetic tactile sensor 341 and the object 120 so they may be sensed by a biomimetic tactile sensor 341 and sensory instrumentation, contact forces may be applied by the biomimetic tactile sensor 341 onto the object 120 that may be in, but not limited to, the range of 0.2-15N of force then the force may be reduced between the biomimetic tactile sensor 341 and object 120 so the biomimetic tactile sensor 341 moves away from the object 120. Contact forces may be increased gradually with time constants between 0.1-1s to evaluate viscoelastic effects. The value of the tactile yielding may be computed by an analytical function 160 that determines a measure of the ratio of displacement recovered when lifting off the object to the total displacement imposed when compressing the object. For example, the total displacement of the biomimetic tactile sensor 341 may be measured as the force is increased and the recovered displacement may be measured as the force is decreased, then the ratio of the displacement recovered when the force is reduced may be divided by the displacement imposed when the force is imposed to compute this tactile property. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force or rates of force loading. Multiple pushing movements may be repeated and the resulting computations of tactile yielding may be averaged to improve measurement accuracy.

To simulate this tactile property with a tactor 250, the operator movement capture system 254 may determine the contact force and compute a corresponding displacement in the tactor 250 which may be applied by moving the tactor 250 away from the fingertip in response to this force. This movement may be implemented with actuators that move the tactor 250. When the operator movement capture system 254 detects a decrease in contact force, the tactor may move the surface back upwards to ensure the appropriate amount of restoration is released back into the finger based on the value of tactile yielding.

### Thermal Cooling

Thermal cooling may be derived from the heat transfer from the heated biomimetic tactile sensor 341 and the object 120 that naturally occurs as they come into contact under force. The rate of heat transfer may be caused by combined effects of temperature and thermal properties of the biomimetic tactile sensor 341 and/or the object 120. In the human fingertip changes in temperature are detected by free nerve endings in the skin. To elicit this heat transfer between the biomimetic tactile sensor 341 and tactile object 120 so they may be sensed by a biomimetic tactile sensor 341, contact forces may be applied by the biomimetic tactile sensor 341 onto the object 120 that may be in, but not limited to, the range of 0.2-15N of force. The value of the thermal cooling may be computed by an analytical function 160 that determines a measure of the rate of heat transfer 1-5s after contact. For example, the derivative of temperature may be computed or directly measured by the biomimetic tactile sensor 341 to determine this value 1-5s after contact to produce this measure. Other signal processing may be possible, for example, if the biomimetic tactile sensor 341 is the BioTac (SynTouch, Los Angeles, Calif.), a high-pass filtered measure of temperature with a bandwidth from 5-1000 Hz may be used as the input signal, which may be measured 1-5s after contact or integrated within this range to produce a measure of thermal cooling. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force. The substrate used to fixture the object 120 may have influence on this tactile property. For instance, if the substrate used is thermally conductive like copper, this property would be reflective of the heat transfer that flows through the object 120. However, if the substrate used is thermally insulative like foam, this property would be reflective of the heat transfer that flows into the object 120. Multiple pushing movements may be repeated and the resulting computations of tactile property may be averaged to improve measurement accuracy.

To simulate this tactile property with a tactor 250, the operator movement capture system 254 may determine the contact force and compute a corresponding heating or cooling curve which may be applied to the tactor 250 through a Peltier element or any other elements designed to heat or cool the human fingertip as familiar to those skilled in the art of heat transfer devices.

### Thermal Persistence

Thermal persistence may be derived from the heat transfer from the heated biomimetic tactile sensor 341 and the object 120 that naturally occurs as they come into contact under force. The rate of heat transfer may be caused by combined effects of temperature and thermal properties of the biomimetic tactile sensor 341 and/or the object 120. In the human fingertip changes in temperature are detected by free nerve endings in the skin. To elicit this heat transfer between the biomimetic tactile sensor 341 and tactile object 120 so they may be sensed by a biomimetic tactile sensor 341, contact forces may be applied by the biomimetic tactile sensor 341 onto the object 120 that may be in, but not limited to, the range of 0.2-15N of force. The value of the thermal persistence may be computed by an analytical function 160 that determines a measure of the rate of heat transfer 5-15s after contact. For example, the derivative of temperature may be computed or directly measured by the biomimetic tactile sensor 341 to determine this value 5-15s after contact to produce this measure. Other signal processing may be possible, for example, if the biomimetic tactile sensor 341 is the BioTac (SynTouch, Los Angeles, Calif.), a high-pass filtered measure of temperature with a bandwidth from 5-1000 Hz may be used as the input signal, which may be measured 5-15s after contact or integrated within this range to produce a measure of thermal persistence. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on an object. Variations may exist for different values of contact force. The substrate used to fixture the object 120 may have influence on this tactile property. For instance, if the substrate used is thermally conductive like copper, this property would be reflective of the heat transfer that flows through the object 120. However, if the substrate used is thermally insulative like foam, this property would be reflective of the heat transfer that flows into the object 120. Multiple pushing movements may be repeated and the resulting computations of tactile property may be averaged to improve measurement accuracy.

To simulate this tactile property with a tactor 250, the operator movement capture system 254 may determine the contact force and compute a corresponding heating or cooling curve which may be applied to the tactor 250 through a Peltier element or any other elements designed to heat or cool the human fingertip as familiar to those skilled in the art of heat transfer devices.

### Adhesion

Adhesion may be derived from the tensile forces in the normal direction that naturally occur as the biomimetic tactile sensor 341 is lifted off of object 120 with adhesive properties after they come into contact under force. The resulting tensile force may be caused by combined adhesive qualities of the biomimetic tactile sensor 341 and object 120, and the initial loading force. In the human fingertip local deformations in the skin may be captured by Merkel discs. To elicit these tensile forces between the biomimetic tactile sensor 341 and object 120 so they may be sensed by a biomimetic tactile sensor 341 and sensory instrumentation, contact forces may be applied by the biomimetic tactile sensor 341 onto object 120 under test that may be in, but not limited to, the range of 0.2-15N of force; then the biomimetic tactile sensor 341 may be separated from object 120 while forces are measured. The value of the adhesion may be computed by an analytical function 160 that provides a measure of change in the normal force while the biomimetic tactile sensor 341 is lifted off of the object. For example the peak tensile force as measured by a load cell may be used to compute this measurement. If the biomimetic tactile sensor 341 is the BioTac (SynTouch, Los Angeles, Calif.) other methods for measuring normal force may be used as described above. The measured value of this tactile property may have a nonlinear transform to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on the object 120. Variations may exist for different values of contact force and lifting speeds. Multiple pushing and lifting movements may be repeated and the resulting computations of tactile property may be averaged to improve measurement accuracy.

To simulate this tactile property with a tactor 250, the operator movement capture system 254 may determine when contact force approaches zero and compute a corresponding adhesion force in the tactor 250 which may be applied by the tactor 250 using electrostatic displays.

### Button Tactile Properties

Tactile properties related to pushbuttons may be derived from the forces, displacements and vibrations that naturally occur between the biomimetic tactile sensor 341 and the pushbutton 520 as they come into contact under force and the pushbutton 520 is depressed and released. In the human fingertip and tendon structure, local deformations in the skin may be captured by Merkel discs while larger displacements may be captured by the muscle spindles in the muscles and tendons driving the finger, vibrations may be captured in the Meissner or Pacinian corpuscles. A humanlike exploratory movement may increase contact force with the pushbutton 520 until it actuates and gradually decrease contact force to deactivate the button. This may be possible with linear or rotary actuators that permit for force control as described above. During the exploratory movement, actuation force may be determine at the onset of a rapid downward movement as detected by position encoders in the actuator without a corresponding rapid increase in force. The force at which this is detected may be used to compute the actuation force. Vibrations measured by the biomimetic tactile sensor 341 during this actuation phase may be recorded and the total energy measured to compute the click intensity. The total travel may be computed by the amount of movement the actuator advances during this actuation event of the pushbutton 520. After the pushbutton 520 is actuated the contact force may gradually be reduced and the deactivation click intensity may be measured by the vibrational energy measured during the disengaging of the pushbutton 520. The measured value of these tactile properties may have one or more nonlinear transforms to convert measurement ranges into more useful forms, such as but not limited to, logarithmic transform, sigmoidal transforms or other transforms as familiar to those skilled in the art of signal processing. Other humanlike exploratory movement sequences and signal processing strategies may be used. For example, a gradually increasing contact force may be used to push on the object 120. Variations may exist for different values of contact force and lifting speeds. Multiple pushing and lifting movements may be repeated and the resulting computations of tactile property may be averaged to improve measurement accuracy.

To simulate this tactile property with a tactor 250, the operator movement capture system 254 may determine the contact force being applied to the tactor 250 by the human fingertip. When the contact force exceeds the actuation force, the tactor 250 may produce vibrations with intensity proportional to the measured click intensity above. When the contact force exceeds the actuation force, the tactor 250 may also move away from the fingertip a distance equal to the total travel. Afterwards, if the contact force as measured by the operator movement capture system 254 is decreased, the tactor 250 may produce vibrations with intensity proportional to the measured deactivation click intensity and/or the tactor 250 may also move back up to its original position.

### Testing Variants

In addition to computing the above tactile properties of an object 120, variants of these tests may exist. For example, many objects have surfaces properties that change one or more tactile properties with repeated exploration, such as the nap of a compressible fabric or skin lotion applied to the skin. To evaluate how these changes, a surface may be tested repeatedly while tactile properties are measured as the surface wears or otherwise changes over time. In another example surfaces may have time dependent properties such as a wet floor that is drying. To evaluate how these properties change over time, a surface may be tested repeatedly over time at a preset interval to measure how these properties change over time. In yet another example, tactile properties including but not limited to those described above may depend on the orientation of an object, a phenomenon known as anisotropy. The feel of such objects may depend on multiple measurements of each tactile property obtained by reorienting the object with respect to object test system 102 and repeating some or all of the humanlike exploratory movements.

### Applications

These tactile exploration, measurement, and perception technologies may be used in quality control and product design and in other fields. The object investigation and classification system 100 may be used in product development applications to determine if one product has a similar feel to another product. In order to determine the tactile properties of a given object 120 under test, the object investigation and classification system 100 may perform humanlike exploratory movements over the object 120 and compute its tactile properties including, but not limited to, those described above. These tactile properties may then be added to an experience database 113 that may be accumulated by performing many humanlike exploratory movements and computing many tactile properties over many objects 120. Design and manufacturing industries for garments, paper goods, consumer electronics, cosmetics, skin and hair care products, prepared foods, and other products commonly employ humans with expertise in classifying objects and materials according to their tactile attributes. Classification according to tactile properties measured by the object investigation and classification system 100 may be useful when designing a product that seeks to mimic the feel of another product, or restore the feel of an object that has been damaged. The above described object investigation and classification system 100 may also be useful for determining which combinations of tactile properties have desirable or undesirable characteristics for a given product type that may be identified in consumer preference studies. Understanding the combinations of tactile properties that are desirable or undesirable can aid in product development by verifying if a new prototype fits within a desirable combination of tactile properties and minimizing the reliance on consumer preference studies. The above-described system may also be useful in applications of quality control where the human perception of noticeable differences is important.

The object investigation and classification system 100 may be used to build up an experience database 113 by causing it to perform one or more repetitions of each humanlike exploratory movement while collecting sensory data to compute tactile properties using analytical functions 160 when exploring various objects 120.

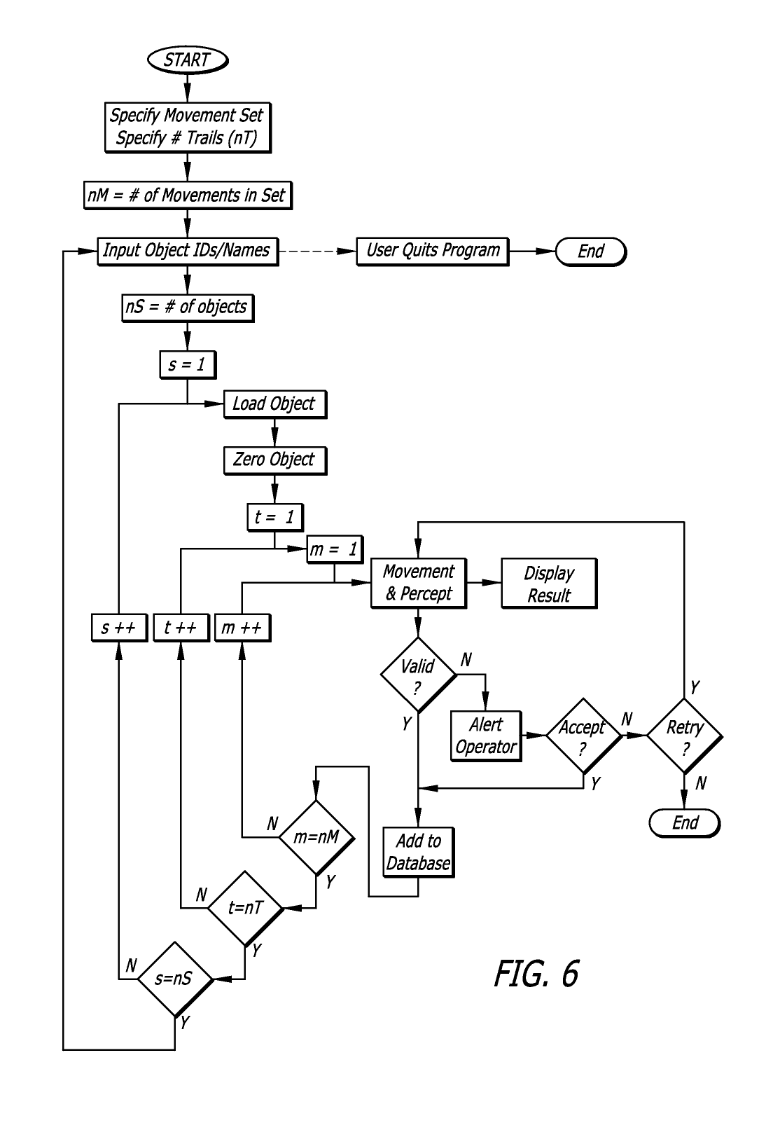

FIG. 6 illustrates an example of a data collection sequence that can be used for the object investigation and classification system 100 illustrated in FIG. 1 to collect information about one or more objects 120.

Referring to FIG. 6, an operator can specify parameters such as the movements and number of trials to complete. The operator can then input information about the objects 120 such as identification numbers and names. The operator may then load the first object 120 into the system and then zero the surface such that the biomimetic tactile sensor 341 is above object 120. The object investigation and classification system 100 may then iterate a process for each trial and each humanlike exploratory movement where the humanlike exploratory movement is performed on object 120, and analytical functions 160 are applied to sensory data to compute one or more tactile properties. The data processing system 101 may compute if the collected information is valid and add it to the experience database 113 if so. If the data is not valid, the data processing system may then alert the operator to determine how they would like to proceed, which may include accepting the data or retrying the test. Advantageously each object 120 may be identified by a material name and other information useful for locating and contacting the source of the material, as well as the values of all the tactile properties obtained from objects made from that material. If more than one repetition of a humanlike exploratory movement is made with a given object 120, then advantageously the value of the tactile properties associated with that movement may be stored as a mean and standard deviation and number of data points in the mean. By assuming that the values obtained for such tactile properties from a single material tend to follow a normal distribution, it may be possible to update the mean and standard deviation of such tactile properties as new experiences with that object 120 occur, using simple statistical methods that are familiar to those skilled in the art of statistics.

After substantial experience with the full range of objects 120 of interest has been collected in the experience database 113, it may be advantageous to normalize the dimensions of the hyperspace to a standard range such as zero to one for each axis of the hyperspace, alternative maximums and minimums for these standardized ranges may be possible. This may be done by dividing each of the values obtained from all the objects 120 for each tactile property by the range of value obtained for each tactile property or other normalization techniques familiar to those skilled in the art of data analysis. This normalization operation may have the effect of insuring that a particular numerical difference between two values of one tactile property corresponds to a similar fraction of the total range of experience for other tactile properties. Alternatively, it may be advantageous to normalize the dimensions of the hyperspace such that a given numerical distance on each dimension corresponds to the just-noticeable-difference (jnd) that human subjects demonstrate for each tactile property. There are many experimental methodologies for determining such jnds that are well-known to persons skilled in the art of sensory psychophysics.

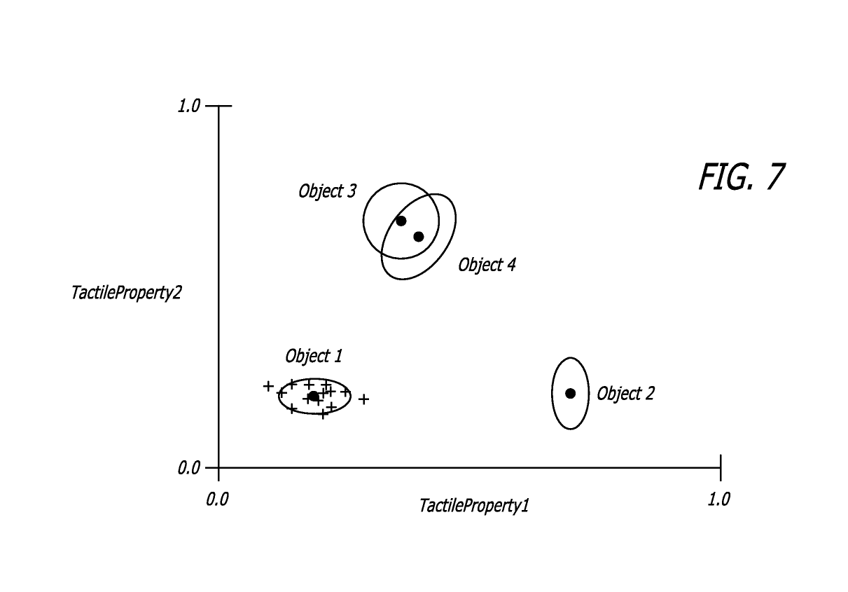

FIG. 7 illustrates an example of objects 120 with different tactile properties measured by the object investigation and classification system 100 illustrated in FIG. 1.

Referring to FIG. 7, a graphical representation of tactile properties of objects may consist of only two dimensions, representing normalized values for TactileProperty1 and TactileProperty2, respectively. The actual measurement values obtained for multiple presentations of Object1 are plotted as small “+” symbols, the mean and standard deviation for each material is plotted as a large dot surrounded by an oval, respectively. In this example, Object1 and Object2 are indistinguishable from each other according to TactileProperty2 but completely non-overlapping in their feel according to TactileProperty1. Object3 and Object4 are highly overlapped in both tactile properties. More generally, any number of tactile properties may be considered to be a hyperspace with a corresponding number of dimensions. Such a hyperspace can be viewed from various perspectives and any number of dimensions may be displayed simultaneously according to the capabilities of the display system, as is well-known to those normally skilled in the art of graphical data displays.

The object investigation and classification system 100 may be used to find objects that are similar in their tactile properties to those measured for an index object. Experience database 113 may then be queried so as to compute a weighted Euclidean distance between the index object and all previously experienced objects whose tactile properties are represented in experience database 113. The un-weighted Euclidean distance between two objects is illustrated in FIG. 7. If some tactile properties are more salient than others for a given use of the object, then the Euclidean distance may be weighted at described below. For example, the goal of the query may be to find objects that are similar in textural feel but not necessarily in thermal properties. In this case, the weights assigned to the tactile properties associated with textural feel may be large and the weights assigned to tactile properties associated with thermal properties may be small. It may also advantageous to correct for the precision or reliability of each tactile property, which may be associated with the inverse of its standard deviation from repeated measurements. The method of Bayesian Exploration performs a similar correction by computing the Bhattacharyya coefficient, a measure of the overlap between two probability density functions; other approaches may be possible as familiar to those skilled in the arts of data analysis. Another advantageous weighting strategy may be to adjust weights based on perceptual saliency to humans whereby the resulting weighted Euclidian distance may correlate with human discriminability. This may be obtained by using the inverse of the standard deviation for discriminating individual tactile properties when evaluated by humans. One general method to compute weighted Euclidean distances is illustrated in the equation:

$${d}_{a \to b} = \sqrt{{\sum }_{i = 1}^{N} {{W}_{i} ( {P}_{i , b} - {P}_{i , a} )}^{2}}$$

where d_{a→b} is the weighted Euclidean distance between objects a and b, P_{i,a} and P_{i,b} are the value for the ith tactile property for objects a and b respectively, Wᵢ is the weighting for the ith tactile property, and N is the number of tactile properties.

Once the weighted Euclidean distances have been computed, the object investigation and classification system 100 may provide a rank ordered list of the objects that would be expected to be perceived by humans to be most similar to the index object. Each object may be identified by the name, source and contact information stored in the experience database 113, enabling the user of our invention to find suppliers of objects that may be incorporated into manufactured goods intended to have a similar feel to the index object or to find manufactured goods that can be expected to have a similar feel to the index object. Weighted Euclidean distances that reflect tactile properties may be used to determine or otherwise influence the ranking or order of presentation of items provided in response to a query in a search engine or as a part of ecommerce.

It may also be possible to use human experience to compute weights that reflect the discriminability of objects by humans, either in absolute terms or according to different purposes of their use. For example, one or more human subjects might be asked to select all items out of a set of materials that “feel the same,” or that “feel suitable for upholstering a car seat,” or that “feel expensive.” A set of weights may then be computed that would cause all of the items so selected to result in weighted Euclidean distances that are small compared to their weighted distances to all of the items not selected. The various sets of weights that achieve these results may themselves be stored and recalled to facilitate searching the experience database 113 for specific queries such as “find all materials that would likely be suitable for upholstering the seats of an expensive car.”

Many of the uses of object investigation and classification system 100 may entail the collection of experiences with new objects and test samples thereof. The identifiers of these new objects and their associated tactile properties may be added to the experience database 113 at any time, thereby steadily expanding the opportunities to find close matches to other objects in the future. One or more object investigation and classification systems 100 may be used to add to the same experience database 113. If the original set of objects of interest used to determine the normalization of the experience database 113 is sufficiently broad, then the tactile properties values associated with the new materials may fall within or close to the normalized ranges of those tactile properties.

Additional dimensions may be added to incorporate non-tactile attributes of materials in the experience database 113 such as density, strength or color that may be available from other test instruments, published data or other sources. This information may be added at any time, so it may be present for some objects and not for others. If it is desired to obtain all objects with certain tactile properties or anticipated feel regardless of whether or not information is available about any non-tactile attributes, then the weights for the irrelevant axes in the experience database 113 may be set to zero. If it is desired to identify only materials that are similar in these other attributes as well as certain tactile properties, then the range of acceptable values of these attributes must be specified and the weights of these attributes may be set high when computing the weighted Euclidean distances. This capability may be used to search experience database 113 for answers to queries such as “find all objects that would be suitable for upholstering car seats according to how they feel and how strong they are.”

The field of optimal control teaches the use of a “cost function” to weight the importance of various state variables of a system in order to compute an optimal solution, which will be well-known to those normally skilled in the field of optimal control engineering. Cost functions often have weighted terms related to performance such as haptic properties and weighted terms related monetary or energetic cost of materials and processes. Experience database 113 may include information about the materials and processes employed to produce objects whose tactile properties are recorded in experience database 113, which can then be used to derive an analytical function between parameters of the design or manufacture of an object and the resulting tactile properties of the object. It may then be possible to compute an optimal selection of materials and processes that will produce the desired object at a minimal cost.

Collected tactile properties of objects in the experience database 113 may be queried to identify object subsets that vary in one specific tactile property, yet are relatively similar across all other tactile properties. This object subset may be used to create samples to help inexperienced human observers appreciate each of the tactile properties and provide or use linguistic tactile descriptors that might otherwise be ambiguous, particularly across language and culture barriers.

Collected tactile properties of objects in the experience database 113 may be queried to identify a diverse set of objects that cover a wide range of multidimensional space for use as a sample book of different objects that exist.

The experience database 113 may also be queried to identify tactile properties of a given object and those tactile properties may be used to drive a tactor 250 to present a simulation of this surface to a human fingertip 260 as described above. This may be used to provide a virtual sample book of different objects that exist. Alternatively, individual tactile properties from an object in the experience database 113 may be directly modified or adjusted before being used to drive the tactile display 250. In one application example, this may be useful to understand how a given object 120 being simulated by the tactor 250 might feel if it differed in one or more of the tactile properties. In another application example, this may be useful to identify new and unique simulated objects that are unlike objects in the experience database 113. In yet another application example, new and unique simulated objects may be determined to have desirable properties and developers may seek to produce objects with these tactile properties and verify they have met these specifications by measuring them on the object investigation and classification system 100.

The object investigation and classification system 100 may be used in pursuit of a variety of business methods. The object investigation and classification system 100 may be sold to industrial test facilities so that they may generate the set of tactile properties required to characterize their products or to correlate with the results of human focus groups. A commercial testing facility may sell access to an object investigation and classification system 100 to characterize samples and products from outside sources. The experience database 113 may be sold separately from or as part of a bundled product including object investigation and classification system 100. Access to the experience database 113 may be provided on a per-use basis to identify materials with the desired feel as part of a service to match buyers and sellers of commercial materials or products in either wholesale or retail trade. Access to the experience database 113 may be bundled as part of the capabilities of on-line search services that make money from subscriptions, per-use fees or advertising fees. Swatch books of sample materials along with the numerical values of their tactile properties may be produced under license and or sold or offered as an advertisement to potential buyers by the sellers of such materials. All of these uses of our invention and business models for deriving revenue from our invention are included within the scope of this invention.

Except as otherwise indicated herein, the data processing system and the various computations, control commands, and other data processing functions that have been discussed herein may be implemented with one or more computer systems configured to perform the functions that have been described. Each computer system may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A system for measuring, storing, and recalling at least one tactile property of multiple objects, the system comprising:
an object test system that includes:
one or more biomimetic tactile sensors that have mechanical properties and sensor modalities that are similar to those of human fingertips; and
one or more mechanical actuators that controllably move the one or more biomimetic tactile sensors;
a data processing system; and
a data storage system;
wherein the object test system, the data processing system, and the data storage system cooperate to:
perform at least one exploratory movement on one of the objects by causing the mechanical actuators to move the biomimetic tactile sensors over a surface of the object, the at least one exploratory movement:
being of a type that a human would normally perform on the object to discern the at least one tactile property; and
having one or more movement parameters, each of the movement parameters falling within a range of movement parameters that would normally be exhibited if a human performed the exploratory movement for the at least one tactile property;
determine a value of the at least one tactile property based on information provided by the biomimetic tactile sensors in response to the exploratory movement, the determining using an analytical function that specifies a mathematical relationship between the value and the information provided by the biomimetic tactile sensors that is based on physical phenomena, rather than extracted from data sets by an adaptive algorithm;
store the determined value in the data storage system along with information identifying the object;
repeat the same exploratory movement performance, the same determining the value using the same analytical function, and the same storing the determined value for each of the other objects; and
read the determined value for each of one or more of the objects from the data storage system.

2. The system of claim 1 wherein:
the object test system includes a temperature or humidity sensor and;
the system uses data from the temperature or humidity sensor to adjust the analytical function.

3. The system of claim 1 wherein:
the object test system includes a temperature or humidity sensor; and
the system uses data from the temperature or humidity sensor to regulate environmental conditions of the object test system.

4. The system of claim 1 wherein:
the object test system includes a fingerprint scanner; and
the system uses data from the fingerprint scanner to determine a state of wear, inflation, or compliance of at least one of the biomimetic tactile sensors.

5. The system of claim 1 wherein:
one of the multiple objects has a non-linear contour; and
the at least one exploratory movement includes changes in elevation and/or orientation of at least one of the biomimetic tactile sensors that cause the at least one of the biomimetic tactile sensors to follow the contour of the object.

6. The system of claim 1 wherein at least one of the biomimetic tactile sensors is connected to at least one of the mechanical actuators by an elastic coupling.

7. The system of claim 1 wherein the system correlates the determined value of the tactile property for each of the objects to one or more linguistic tactile descriptors that a human uses to describe how an object feels.

8. The system of claim 1 wherein the system:
determines the value of each of multiple different properties of each of the multiple objects; and
scales the determined values of at least two of the different properties so that the ranges of the majority of the values for the at least two different properties are substantially the same.

9. The system of claim 8 wherein the system determines:
the value of each of multiple different tactile properties of each of the multiple objects; and
the similarity between at least one pair of objects by computing a Euclidean distance between the values of each of the different tactile properties of the pair of objects.

10. The system of claim 1 wherein the system:
determines the value of each of multiple different properties of each of the multiple objects; and
scales the determined values of at least two of the different properties so that the same increment of value for each of the at least two different properties corresponds to the smallest difference that a human can discriminate for that property.

11. The system of claim 1 wherein the system has a configuration that causes the data storage system to store values of tactile properties of the objects that have been determined by more than one test systems.

12. The system of claim 1 wherein the system has a configuration that causes the data storage system to store data for each object that describes non-tactile properties of the object.

13. The system of claim 12 wherein the system computes a cost function for each object and identifies one or more of the objects that satisfy one or more requirements based on the determined cost functions.

14. The system of claim 1 wherein the system computes a cost function for each object and identifies one or more of the objects that satisfy one or more requirements based on the determined cost functions.

15. The system of claim 1 wherein:
the tactile property is macrotexture roughness;
the biomimetic tactile sensors include a vibration sensor that produces a time-varying signal indicative of vibration;
the exploratory movement includes sliding the vibration sensor across a surface of the object with a normal force in the range of 0.2-2 N and a tangential velocity in the range of 0.5-10 cm/s; and
the analytical function determines a measure of vibration intensity in the time-varying signal in a frequency band that is within 5-100 Hz.

16. The system of claim 1 wherein:
the tactile property is microtexture roughness;
the biomimetic tactile sensors include a vibration sensor that produces a time-varying signal indicative of vibration;
the exploratory movement includes sliding the vibration sensor across a surface of the object with a normal force in the range of 0.2-2 N and a tangential velocity in the range of 0.5-10 cm/s; and
the analytical function determines a measure of vibration intensity in the time-varying signal in a frequency band that is within 20-800 Hz.

17. The system of claim 1 wherein:
the tactile property is macrotexture coarseness;
the biomimetic tactile sensors include a vibration sensor that produces a time-varying signal indicative of vibration;
the exploratory movement includes sliding the vibration sensor across a surface of the object with a normal force in the range of 0.2-2 N and a tangential velocity in the range of 0.5-10 cm/s; and
the analytical function determines a measure of vibration frequency in the time-varying signal in a frequency band that is within 5-100 Hz.

18. The system of claim 1 wherein:
the tactile property is microtexture coarseness;
the biomimetic tactile sensors include a vibration sensor that produces a time-varying signal indicative of vibration;
the exploratory movement includes sliding the vibration sensor across a surface of the object with a normal force in the range of 0.2-2 N and a tangential velocity in the range of 0.5-10 cm/s; and
the analytical function determines a measure of a vibration frequency in the time-varying signal in a frequency band that is within 20-800 Hz.

19. The system of claim 1 wherein:
the tactile property is macrotexture regularity;
the biomimetic tactile sensors include a vibration sensor that produces a time-varying signal indicative of vibration;
the exploratory movement includes sliding the vibration sensor across a surface of the object with a normal force in the range of 0.2-2 N and a tangential velocity in the range of 0.5-10 cm/s; and
the analytical function determines a measure of a distribution of vibration frequency content in the time-varying signal in a frequency band that is within 5-100 Hz.

20. The system of claim 1 wherein:
the tactile property is tactile stiction;
the system computes a time-varying signal indicative of tangential force;
the exploratory movement includes sliding a biomimetic tactile sensor across a surface of the object with a normal force in the range of 0.2-2 N and a tangential velocity in the range of 0.5-10 cm/s; and
the analytical function determines a measure of a peak tangential force in the time-varying signal as the biomimetic tactile sensor transitions from rest to sliding.

21. The system of claim 1 wherein:
the tactile property is tactile sliding resistance;
the system computes a time-varying signal indicative of tangential force;
the exploratory movement includes sliding a biomimetic tactile sensor across a surface of the object with a normal force in the range of 0.2-2 N and a tangential velocity in the range of 0.5-10 cm/s; and
the analytical function determines a measure of average tangential force in the time-varying signal.

22. The system of claim 1 wherein:
the tactile property is tactile stick-slip chatter;
the system computes a time-varying signal indicative of tangential force;
the exploratory movement includes sliding a biomimetic tactile sensor across a surface of the object with a normal force in the range of 0.2-2 N and a tangential velocity in the range of 0.5-10 cm/s; and
the analytical function determines a measure of variation in the tangential force in the time-varying signal.

23. The system of claim 1 wherein:
the tactile property is tactile compliance;
the system computes time-varying signals indicative of normal force and displacement;
the exploratory movement includes pushing a biomimetic tactile sensor into a surface of the object with a normal force in the range of 0.2-15 N; and
the analytical function determines a measure of a ratio of displacement to normal force in the time-varying signals.

24. The system of claim 1 wherein:
the tactile property is tactile deformability;
the biomimetic tactile sensors include a sensor that measures pressure or a distributed array of force and that produce a time-varying signal indicative of local deformation;
the exploratory movement includes pushing a biomimetic tactile sensor into a surface of the object with a normal force in the range of 0.2-15 N; and
the analytical function determines a measure of the local deformation from the time-varying signal.

25. The system of claim 1 wherein:
the tactile property is tactile damping;
the system computes time-varying signals indicative of normal force and displacement;
the exploratory movement includes pushing a biomimetic tactile sensor into a surface of the object with a normal force in the range of 0.2-15 N and then reducing that force while maintaining contact with the object; and
the analytical function determines a measure of a ratio of energy recovered from the object during the lifting to energy required to compress the object in the time-varying signals.

26. The system of claim 1 wherein:
the tactile property is tactile relaxation;
the system computes time-varying signals indicative of normal force;
the exploratory movement includes pushing a biomimetic tactile sensor into a surface of the object with a normal force in the range of 0.2-15 N and holding the biomimetic tactile sensor in place; and
the analytical function determines a measure of change in the normal force while the biomimetic tactile sensor is held in place from the time-varying signal.

27. The system of claim 1 wherein:
the tactile property is tactile yielding;
the system computes time-varying signals indicative of displacement;
the exploratory movement includes pushing a biomimetic tactile sensor into a surface of the object with a normal force in the range of 0.2-15 N and then reducing that force while maintaining contact with the object; and
the analytical function determines a measure of a ratio of displacement recovered after reduction of force to displacement imposed during the pushing from the time-varying signals.

28. The system of claim 1 wherein:
the tactile property is thermal cooling;
one of the biomimetic tactile sensors includes at least one temperature sensor within it that produces a time-varying signal indicative of heat transfer into or out of the at least one temperature sensor;
the exploratory movement includes pushing the one of the biomimetic tactile sensors against a surface of the object with a normal force in the range of 0.2-15 N and holding the one of the biomimetic tactile sensors in place after the pushing; and
the analytical function determines a measure of a rate of heat transfer in the time-varying signal that takes place between 1-5 seconds after the one of the biomimetic tactile sensors contacts the object.

29. The system of claim 1 wherein:
the tactile property is thermal persistence;
one of the biomimetic tactile sensors includes at least one temperature sensor within it that produces time-varying signals indicative of heat transfer into or out of the at least one temperature sensor;
the exploratory movement includes pushing the one of the biomimetic tactile sensors at least one temperature sensor into a surface of the object with a normal force in the range of 0.2-15 N and thereafter holding the one of the biomimetic tactile sensors in place; and
the analytical function determines a measure of a rate of heat transfer in the time-varying signal that takes place between 5-15 seconds after the one of the biomimetic tactile sensors contacts the object.

30. The system of claim 1 wherein:
the tactile property is adhesion;
the system computes time-varying signals indicative of normal force;
the exploratory movement includes pushing a biomimetic tactile sensor against a surface of the object with a normal force in the range of 0.2-15 N and then lifting the biomimetic tactile sensor off of the object; and
the analytical function determines a measure of change in the normal force while the biomimetic tactile sensor is lifted off of the object from the time-varying signal.

31. The system of claim 1 wherein:
one of the test objects is a pushbutton;
the tactile property is actuation force, click intensity, total travel, or deactivation click intensity;
the biomimetic tactile sensors include a vibration sensor;
the system computes time-varying signals indicative of normal force and displacement;
the exploratory movement includes pushing the vibration sensor against a surface of the pushbutton with an increasing normal force until the pushbutton actuates and then releasing the force while allowing the pushbutton to push the biomimetic tactile sensor back up; and
the analytical function determines:
an amount of force required to actuate the pushbutton from the time-varying force signal;
an intensity of vibrations during the actuation;
total travel during the pushing; or
intensity of vibrations during the release.

32. The system of claim 1 wherein the system generates and displays or prints an image that represents at least one tactile property of at least one object based on the determined value of the at least one tactile property of the object.

33. The system of claim 1 further comprising a tactor and wherein the system controls the tactor based on the determined value of the at least one tactile property of one of the objects.

34. The system of claim 33 wherein the system adjusts the determined value of the at least one tactile property of the object before the system controls the tactor.

35. A non-transitory, tangible, computer-readable storage medium containing a program of instructions that causes a system for measuring, storing, and recalling at least one tactile property of multiple objects that is running the program of instructions, the system including an object test system that includes one or more biomimetic tactile sensors that have mechanical properties and sensor modalities that are similar to those of human fingertips and one or more mechanical actuators that controllably move the one or more biomimetic tactile sensors, a data processing system, and a data storage system, to:
perform at least one exploratory movement on one of the objects by causing the mechanical actuators to move the biomimetic tactile sensors over a surface of the object, the at least one exploratory movement:
being of a type that a human would normally perform on the object to discern the at least one tactile property; and
having one or more movement parameters, each of the movement parameters falling within a range of movement parameters that would normally be exhibited if a human performed the exploratory movement for the at least one tactile property;
determine a value of the at least one tactile property based on information provided by the biomimetic tactile sensors in response to the exploratory movement, the determining using an analytical function that specifies a mathematical relationship between the value and the information provided by the biomimetic tactile sensors that is based on physical phenomena, rather than extracted from data sets by an adaptive algorithm;
store the determined value in the data storage system along with information identifying the object;
repeat the same exploratory movement performance, the same determining the value using the same analytical function, and the same storing the determined value for each of the other objects; and
read the determined value for each of one or more of the objects from the data storage system.
